(19) United States
(12) Patent Application Publication
(10) Pub. No.: US 2025/0324154 A1
(43) Pub. Date: Oct. 16, 2025

(54) STROBED LIGHT FOR ENHANCED VIDEO CAPTURE

(71) Applicant: GoPro, Inc., San Mateo, CA (US)

(72) Inventors: Jérôme Daniel Hourioux, Puteaux (FR); Gladys Jocelyne Marc, Paris (FR)

(21) Appl. No.: 18/631,679

(22) Filed: Apr. 10, 2024

(51) Int. Cl. H04N 23/56; H04N 23/13; H04N 23/51; H04N 23/667; H04N 23/88

(52) U.S. Cl. CPC H04N 23/56; H04N 23/13; H04N 23/51; H04N 23/667; H04N 23/88

(57) ABSTRACT

Systems and methods are described for strobed light for enhanced video capture. For example, some methods include accessing a first frame of video that is captured while an artificial light source is emitting light; accessing a second frame of video that is captured while the artificial light source is off; determining a parameter based on the second frame of video; and modifying the first frame of video based on the parameter. The artificial light source may be configured to emit light in a strobe pattern that is synchronized with periodic capture of frames of video using the image sensor. For example, the parameter may be a tuple of automatic white balance scale factors or a luminance scale factor.

### TECHNICAL FIELD

This disclosure relates to strobed light for enhanced video capture.

### BACKGROUND

Image capture devices, such as cameras, may capture content as images (e.g., still images or frames of video). Light may be received and focused via a lens and may be converted to an electronic image signal by an image sensor. The image signal may be processed by an image signal processor (ISP) to form an image, which may be stored and/or encoded. Some environments may have insufficient natural light to provide a desired signal to noise ratio in an electronic image signal captured by the image sensor. To enhance the signal to noise ratio, an artificial light source (e.g., a flash) may be used while capturing an image.

### SUMMARY

Disclosed herein are implementations of strobed light for enhanced video capture.

In a first aspect, the subject matter described in this specification can be embodied in systems that include a first image sensor, a second image sensor with a field of view that overlaps with a field of view of the first image sensor, an artificial light source configured to emit light in a strobe pattern that is synchronized with periodic capture of frames of video using the second image sensor, and a processing apparatus configured to: access a first frame of video from the first image sensor; access a second frame of video from the second image sensor that is captured while the artificial light source is off; determine a parameter based on the second frame of video; and modify the first frame of video based on the parameter.

In the first aspect, the artificial light source may include one or more light emitting diodes. In the first aspect, the parameter may be a tuple of automatic white balance scale factors. In the first aspect, the parameter may be a luminance scale factor used to adjust a contrast of the first frame of video. In the first aspect, the parameter may be a luminance scale factor used to adjust a brightness of the first frame of video. In the first aspect, the second image sensor may have a lower resolution than the first image sensor. In the first aspect, the second image sensor may be a single pixel. In the first aspect, an exposure time used to capture the first frame of video with the first image sensor may be a multiple of a period of the strobe pattern. In the first aspect, the first image sensor and the second image sensor may both be permanently attached to a body of an image capture device. In the first aspect, the first image sensor may be permanently attached to a body of an image capture device, and the second image sensor and the artificial light source may both be integrated in a flash accessory that is removably attached to the body of the image capture device. In the first aspect, the flash accessory may be removably attached to the body of the image capture device using a bayonet mechanism. In the first aspect, the processing apparatus may be configured to: determine an artificial lighting ratio for a portion of the first frame of video by comparing the portion of the first frame of video to a corresponding portion of the second frame of video; and determine the parameter based on the artificial lighting ratio, wherein the parameter is used to modify the portion of the first frame of video. In the first aspect, the portion of the first frame of video may correspond to a pixel of a reduced resolution thumbnail of the first frame of video, and a luminance value of the pixel may be used to determine the artificial lighting ratio. In the first aspect, the processing apparatus may be configured to: determine the parameter as a convex sum of a first parameter value associated with the first frame of video and a second parameter value associated with the second frame of video, wherein coefficients of the convex sum are determined based on the artificial lighting ratio.

In a second aspect, the subject matter described in this specification can be embodied in methods that include accessing a first frame of video that is captured while an artificial light source is emitting light; accessing a second frame of video that is captured while the artificial light source is off; determining a parameter based on the second frame of video; and modifying the first frame of video based on the parameter.

In the second aspect, the first frame of video and the second frame of video may be captured using a same image sensor. In the second aspect, the first frame of video may be captured using a first image sensor and the second frame of video may be captured using a second image sensor with field of view that overlaps with a field of view of the first image sensor. In the second aspect, the second image sensor may have a lower resolution than the first image sensor. In the second aspect, the second image sensor may be a single pixel. In the second aspect, the artificial light source may emit light in a strobe pattern that is synchronized with periodic capture of frames of video, the frames of video including the second frame of video. In the second aspect, an exposure time used to capture the first frame of video may be a multiple of a period of the strobe pattern. In the second aspect, the parameter may be a tuple of automatic white balance scale factors. In the second aspect, the parameter may be a luminance scale factor used to adjust a contrast of the first frame of video. In the second aspect, the parameter may be a luminance scale factor used to adjust a brightness of the first frame of video. In the second aspect, the methods may include determining an artificial lighting ratio for a portion of the first frame of video by comparing the portion of the first frame of video to a corresponding portion of the second frame of video; and determining the parameter based on the artificial lighting ratio, wherein the parameter is used to modify the portion of the first frame of video. In the second aspect, the portion of the first frame of video may correspond to a pixel of a reduced resolution thumbnail of the first frame of video, and a luminance value of the pixel may be used to determine the artificial lighting ratio. In the second aspect, the methods may include determining the parameter as a convex sum of a first parameter value associated with the first frame of video and a second parameter value associated with the second frame of video, wherein coefficients of the convex sum are determined based on the artificial lighting ratio.

In a third aspect, the subject matter described in this specification can be embodied in a non-transitory computer-readable storage medium. The non-transitory computer-readable storage medium may include executable instructions that, when executed by a processor, cause performance of operations, including accessing a first frame of video that is captured while an artificial light source is emitting light; accessing a second frame of video that is captured while the artificial light source is off; determining a parameter based on the second frame of video; and modifying the first frame of video based on the parameter.

In the third aspect, the first frame of video and the second frame of video may be captured using a same image sensor. In the third aspect, the first frame of video may be captured using a first image sensor and the second frame of video may be captured using a second image sensor with field of view that overlaps with a field of view of the first image sensor. In the third aspect, the second image sensor may have a lower resolution than the first image sensor. In the third aspect, the second image sensor may be a single pixel. In the third aspect, the artificial light source may emit light in a strobe pattern that is synchronized with periodic capture of frames of video, the frames of video including the second frame of video. In the third aspect, an exposure time used to capture the first frame of video may be a multiple of a period of the strobe pattern. In the third aspect, the parameter may be a tuple of automatic white balance scale factors. In the third aspect, the parameter may be a luminance scale factor used to adjust a contrast of the first frame of video. In the third aspect, the parameter may be a luminance scale factor used to adjust a brightness of the first frame of video. In the third aspect, the operations may include determining an artificial lighting ratio for a portion of the first frame of video by comparing the portion of the first frame of video to a corresponding portion of the second frame of video; and determining the parameter based on the artificial lighting ratio, wherein the parameter is used to modify the portion of the first frame of video. In the third aspect, the portion of the first frame of video may correspond to a pixel of a reduced resolution thumbnail of the first frame of video, and a luminance value of the pixel may be used to determine the artificial lighting ratio. In the third aspect, the operations may include determining the parameter as a convex sum of a first parameter value associated with the first frame of video and a second parameter value associated with the second frame of video, wherein coefficients of the convex sum are determined based on the artificial lighting ratio.

In a fourth aspect, the subject matter described in this specification can be embodied in systems that include an image sensor, an artificial light source, and a processing apparatus configured to: access a first frame of video from the image sensor that is captured while the artificial light source is emitting light; access a second frame of video from the image sensor that is captured while the artificial light source is off; determine a parameter based on the second frame of video; and modify the first frame of video based on the parameter.

In the fourth aspect, the artificial light source may be configured to emit light in a strobe pattern that is synchronized with periodic capture of frames of video using the image sensor. In the fourth aspect, the image sensor may be configured to capture frames of video with a rolling shutter, a frame rate of the image sensor may be four times a frequency of the strobe pattern, and the processing apparatus may be configured to: discard frames with a period of rolling shutter capture that includes an edge of the strobe pattern. In the fourth aspect, the artificial light source may include one or more light emitting diodes. In the fourth aspect, the parameter may be a tuple of automatic white balance scale factors. In the fourth aspect, the parameter may be a luminance scale factor used to adjust a contrast of the first frame of video. In the fourth aspect, the parameter may be a luminance scale factor used to adjust a brightness of the first frame of video. In the fourth aspect, the processing apparatus may be configured to: determine an artificial lighting ratio for a portion of the first frame of video by comparing the portion of the first frame of video to a corresponding portion of the second frame of video; and determine the parameter based on the artificial lighting ratio, wherein the parameter is used to modify the portion of the first frame of video. In the fourth aspect, the portion of the first frame of video may correspond to a pixel of a reduced resolution thumbnail of the first frame of video, and a luminance value of the pixel may be used to determine the artificial lighting ratio. In the fourth aspect, the processing apparatus may be configured to determine the parameter as a convex sum of a first parameter value associated with the first frame of video and a second parameter value associated with the second frame of video, wherein coefficients of the convex sum are determined based on the artificial lighting ratio.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-1B are isometric views of an example of an image capture apparatus.

FIGS. 2A-1B are isometric views of another example of an image capture apparatus.

FIG. 3 is a top view of another example of an image capture apparatus.

FIGS. 4A-4B are isometric views of another example of an image capture apparatus.

FIG. 5 is a block diagram of electronic components of an image capture apparatus.

FIG. 6 is a flow diagram of an example of an image processing pipeline.

FIG. 7 is a block diagram of an example of a system configured to use strobed light for enhanced video capture.

FIG. 8 is a block diagram of an example of a system configured to use strobed light with a pair of image sensors for enhanced video capture.

FIG. 9 is a block diagram of an example of a system configured to use strobed light from a flash accessory with an additional image sensor for enhanced video capture.

FIG. 10 is flowchart of an example of a process for using strobed light for enhanced video capture by modifying a first frame of video captured with artificial light based on a second frame of video captured without the artificial light.

FIG. 11 is flowchart of an example of a process for determining a parameter for modifying the first frame of video based on the second frame of video.

### DETAILED DESCRIPTION

In low light conditions, videos may be affected by noise and long exposure times that can cause blurry images. It is possible to use an additional artificial light source to alleviate these impairments. However, the artificial light may change the atmosphere of the scene. For example, the color temperature of the artificial light usually does not match the color temperature of the natural light of the scene. In some cases, the background portions of a scene may be underexposed compared to the foreground portions. Also, the camera may choose different white balance settings than it would have chosen with only the natural light. In the end, videos captured with an additional artificial light may have a characteristic look that greatly differs from the same video taken only with natural light.

Some implementations described herein enable capture of video shot with an additional artificial light, while rendering the scene as if it was taken with only the natural light. For example, the artificial light may be strobed so that the sensor can sample the scene with only natural light when the artificial light is off. Some implementations use strobed light (e.g., from a flash accessory for a camera) synchronized with image sensor exposure during video capture.

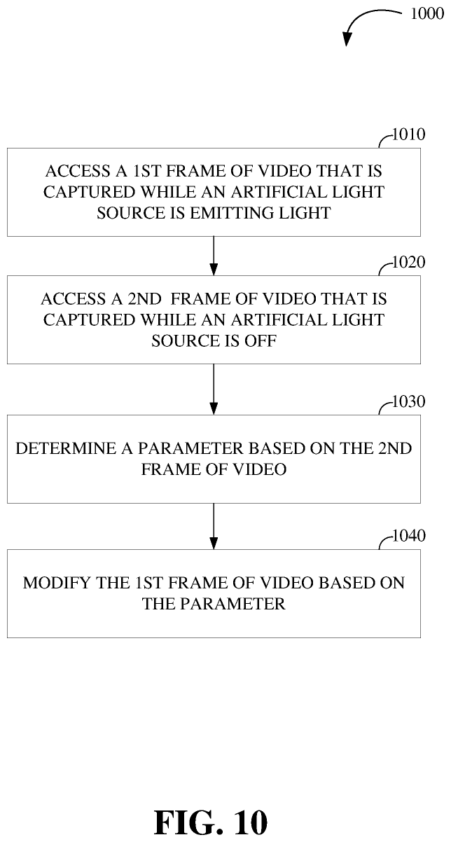

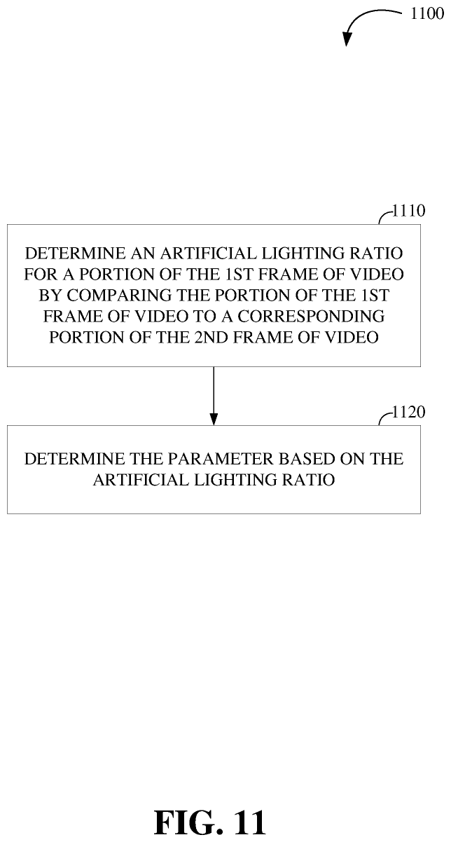

Numerous hardware setups may be used. In an example, the light may be strobed in sync with image sensor exposure, where the image sensor uses a rolling shutter. In this example, the sensor frame rate is four times the light strobe frequency. In the rolling shutter case, the capture of different images portions (e.g., rows of pixels) for consecutive frames of video may overlap in time. Considering a sequence of four image sensor exposures in this scenario: one frame will be consistently exposed with artificial light plus natural light; one frame will be partially exposed (e.g., with mix of artificial light in some rolling shutter regions, but not other rolling shutter regions) because it is captured during a period that includes a negative edge of the strobe pattern for the artificial light source, and may thus be discarded; one frame will be consistently exposed with natural light only; and a second frame will be partially exposed because it is captured during a period that includes a positive edge of the strobe pattern for the artificial light source, and may thus be discarded. The two non-discarded frames may be kept for a further processing (e.g., as described in relation to FIGS. 10-11).

In an example, the light may be strobed in sync with image sensor exposure, where the image sensor uses a global shutter. In this example, the image sensor frame rate is twice the light strobe frequency. Considering a sequence of two image sensor exposures in this scenario: one frame will be consistently exposed with artificial light plus natural light; and one frame will be consistently exposed with natural light only. The two frames may be kept for a further processing (e.g., as described in relation to FIGS. 10-11).

In an example, two image sensors may be used, including a main image sensor that is doing the image capture for a video signal, and a secondary image sensor with an overlapping field of view that is synchronized with the strobed light and is used to sample the natural light of the scene. The secondary image sensor may be of lower resolution compared to the main image sensor. In extreme cases the secondary image sensor can be a single pixel (e.g., an RGB photodiode). The secondary image sensor uses one of synchronization setups described above to ensure periodic capture of an image without artificial light from the strobed light source. The main image sensor may only be constrained to exposure times that are a multiple of the strobed light period. For example, if the light is strobed at 300 Hz, the strobe period is 3.3 ms. Hence, the main image sensor may be constrained to exposure times of 3.3 ms, 6.7 ms, 10 ms, . . . . If this constraint holds, all captured frames from the main image sensor are evenly lit. 300 Hz may be particularly useful strobe frequency, because it is high enough not to be seen by the human eye and it is a multiple of both 50 Hz and 60 Hz, and hence it does not interfere with existing anti-flickering methods. In some implementations, information from the secondary image sensor, especially from frames lit with only natural light, is combined with the images captured by the main image sensor using an image processing algorithm to correct for impairments caused by the artificial light (e.g., as described in relation to FIGS. 10-11). In some implementations, information from the secondary image sensor is used to adjust the strobed light color and intensity, so that the artificial additional light matches the natural light to mitigate disruption of the scene atmosphere by the artificial light. An algorithm for processing the main image sensor images may utilize a priori knowledge that an additional light source is used without using information coming from the secondary image sensor otherwise.

Some implementations use image processing for artificial light (e.g., flashlight) color correction using strobed light synchronized with sensor exposure. As described above, strobed light synchronized with sensor exposure may be captured in a variety of ways to obtain pairs of images (e.g., frames of video), one image with artificial light on and another image with artificial light off. Note that artificial light may impact different portions (e.g., background portions versus foreground portions) of an image differently depending on the amount of the artificial light that is reflected back to the image sensor for a portion of the image. For example, the image without artificial light may be used to estimate background illumination of the scene and to compute locally the impact of the artificial light. Then the artificially illuminated image may be locally corrected with weighted correction between an image processing parameter calibrated for the artificial light illuminant and an image processing parameter calibrated for the natural lighting of a scene depending on local impact of the artificial light (e.g., flash).

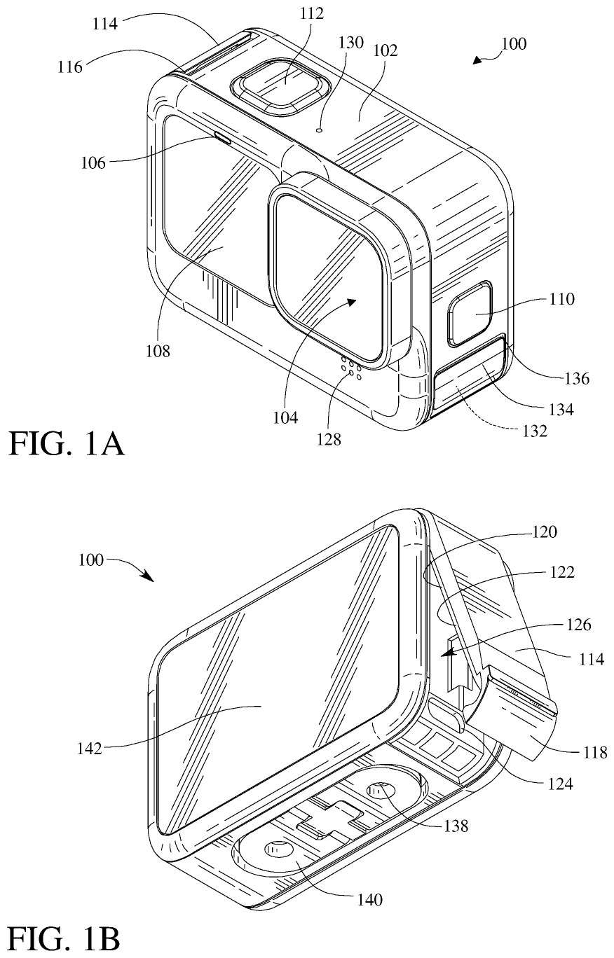

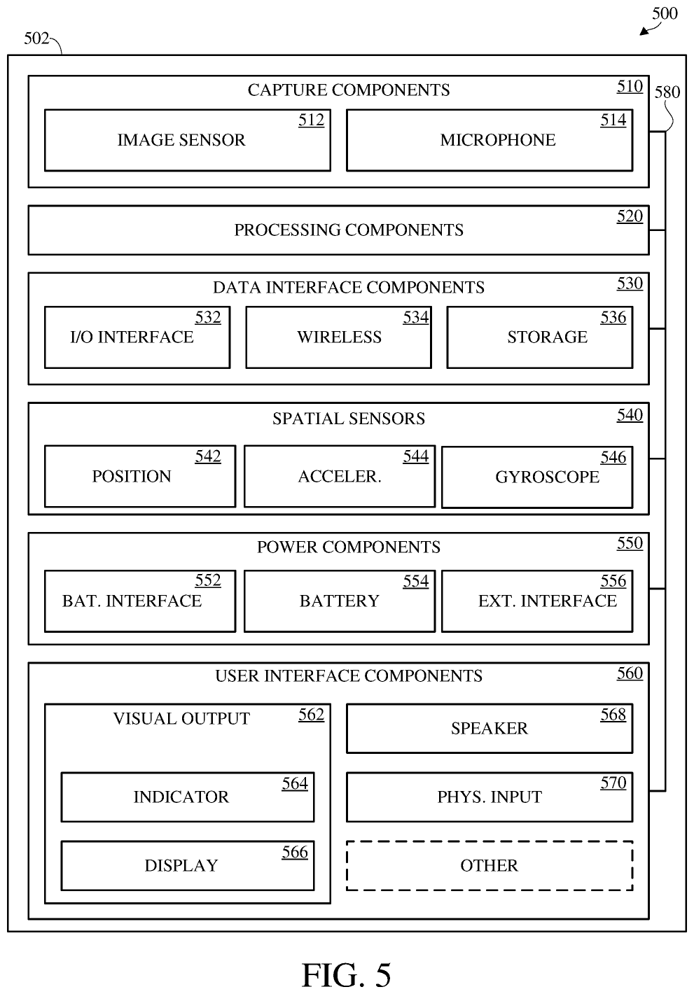

FIGS. 1A-1B are isometric views of an example of an image capture apparatus 100. The image capture apparatus 100 includes a body 102, an image capture device 104, an indicator 106, a display 108, a mode button 110, a shutter button 112, a door 114, a hinge mechanism 116, a latch mechanism 118, a seal 120, a battery interface 122, a data interface 124, a battery receptacle 126, microphones 128, 130, 132, a speaker 138, an interconnect mechanism 140, and a display 142. Although not expressly shown in FIGS. 1A-1B, the image capture apparatus 100 includes internal electronics, such as imaging electronics, power electronics, and the like, internal to the body 102 for capturing images and performing other functions of the image capture apparatus 100. An example showing internal electronics is shown in FIG. 5. The arrangement of the components of the image capture apparatus 100 shown in FIGS. 1A-1B is an example, other arrangements of elements may be used, except as is described herein or as is otherwise clear from context.

The body 102 of the image capture apparatus 100 may be made of a rigid material such as plastic, aluminum, steel, or fiberglass. Other materials may be used. The image capture device 104 is structured on a front surface of, and within, the body 102. The image capture device 104 includes a lens. The lens of the image capture device 104 receives light incident upon the lens of the image capture device 104 and directs the received light onto an image sensor of the image capture device 104 internal to the body 102. The image capture apparatus 100 may capture one or more images, such as a sequence of images, such as video. The image capture apparatus 100 may store the captured images and video for subsequent display, playback, or transfer to an external device. Although one image capture device 104 is shown in FIG. 1A, the image capture apparatus 100 may include multiple image capture devices, which may be structured on respective surfaces of the body 102.

As shown in FIG. 1A, the image capture apparatus 100 includes the indicator 106 structured on the front surface of the body 102. The indicator 106 may output, or emit, visible light, such as to indicate a status of the image capture apparatus 100. For example, the indicator 106 may be a light-emitting diode (LED). Although one indicator 106 is shown in FIG. 1A, the image capture apparatus 100 may include multiple indictors structured on respective surfaces of the body 102.

As shown in FIG. 1A, the image capture apparatus 100 includes the display 108 structured on the front surface of the body 102. The display 108 outputs, such as presents or displays, such as by emitting visible light, information, such as to show image information such as image previews, live video capture, or status information such as battery life, camera mode, elapsed time, and the like. In some implementations, the display 108 may be an interactive display, which may receive, detect, or capture input, such as user input representing user interaction with the image capture apparatus 100. In some implementations, the display 108 may be omitted or combined with another component of the image capture apparatus 100.

As shown in FIG. 1A, the image capture apparatus 100 includes the mode button 110 structured on a side surface of the body 102. Although described as a button, the mode button 110 may be another type of input device, such as a switch, a toggle, a slider, or a dial. Although one mode button 110 is shown in FIG. 1A, the image capture apparatus 100 may include multiple mode, or configuration, buttons structured on respective surfaces of the body 102. In some implementations, the mode button 110 may be omitted or combined with another component of the image capture apparatus 100. For example, the display 108 may be an interactive, such as touchscreen, display, and the mode button 110 may be physically omitted and functionally combined with the display 108.

As shown in FIG. 1A, the image capture apparatus 100 includes the shutter button 112 structured on a top surface of the body 102. The shutter button 112 may be another type of input device, such as a switch, a toggle, a slider, or a dial. The image capture apparatus 100 may include multiple shutter buttons structured on respective surfaces of the body 102. In some implementations, the shutter button 112 may be omitted or combined with another component of the image capture apparatus 100.

The mode button 110, the shutter button 112, or both, obtain input data, such as user input data in accordance with user interaction with the image capture apparatus 100. For example, the mode button 110, the shutter button 112, or both, may be used to turn the image capture apparatus 100 on and off, scroll through modes and settings, and select modes and change settings.

As shown in FIG. 1B, the image capture apparatus 100 includes the door 114 coupled to the body 102, such as using the hinge mechanism 116 (FIG. 1A). The door 114 may be secured to the body 102 using the latch mechanism 118 that releasably engages the body 102 at a position generally opposite the hinge mechanism 116. The door 114 includes the seal 120 and the battery interface 122. Although one door 114 is shown in FIG. 1A, the image capture apparatus 100 may include multiple doors respectively forming respective surfaces of the body 102, or portions thereof. The door 114 may be removable from the body 102 by releasing the latch mechanism 118 from the body 102 and decoupling the hinge mechanism 116 from the body 102.

In FIG. 1B, the door 114 is shown in a partially open position such that the data interface 124 is accessible for communicating with external devices and the battery receptacle 126 is accessible for placement or replacement of a battery. In FIG. 1A, the door 114 is shown in a closed position. In implementations in which the door 114 is in the closed position, the seal 120 engages a flange (not shown) to provide an environmental seal and the battery interface 122 engages the battery (not shown) to secure the battery in the battery receptacle 126.

As shown in FIG. 1B, the image capture apparatus 100 includes the battery receptacle 126 structured to form a portion of an interior surface of the body 102. The battery receptacle 126 includes operative connections for power transfer between the battery and the image capture apparatus 100. In some implementations, the battery receptacle 126 may be omitted. The image capture apparatus 100 may include multiple battery receptacles.

As shown in FIG. 1A, the image capture apparatus 100 includes a first microphone 128 structured on a front surface of the body 102, a second microphone 130 structured on a top surface of the body 102, and a third microphone 132 structured on a side surface of the body 102. The third microphone 132, which may be referred to as a drain microphone and is indicated as hidden in dotted line, is located behind a drain cover 134, surrounded by a drain channel 136, and can drain liquid from audio components of the image capture apparatus 100. The image capture apparatus 100 may include other microphones on other surfaces of the body 102. The microphones 128, 130, 132 receive and record audio, such as in conjunction with capturing video or separate from capturing video. In some implementations, one or more of the microphones 128, 130, 132 may be omitted or combined with other components of the image capture apparatus 100.

As shown in FIG. 1B, the image capture apparatus 100 includes the speaker 138 structured on a bottom surface of the body 102. The speaker 138 outputs or presents audio, such as by playing back recorded audio or emitting sounds associated with notifications. The image capture apparatus 100 may include multiple speakers structured on respective surfaces of the body 102.

As shown in FIG. 1B, the image capture apparatus 100 includes the interconnect mechanism 140 structured on a bottom surface of the body 102. The interconnect mechanism 140 removably connects the image capture apparatus 100 to an external structure, such as a handle grip, another mount, or a securing device. The interconnect mechanism 140 includes folding protrusions configured to move between a nested or collapsed position as shown in FIG. 1B and an extended or open position. The folding protrusions of the interconnect mechanism 140 in the extended or open position may be coupled to reciprocal protrusions of other devices such as handle grips, mounts, clips, or like devices. The image capture apparatus 100 may include multiple interconnect mechanisms structured on, or forming a portion of, respective surfaces of the body 102. In some implementations, the interconnect mechanism 140 may be omitted.

As shown in FIG. 1B, the image capture apparatus 100 includes the display 142 structured on, and forming a portion of, a rear surface of the body 102. The display 142 outputs, such as presents or displays, such as by emitting visible light, data, such as to show image information such as image previews, live video capture, or status information such as battery life, camera mode, elapsed time, and the like. In some implementations, the display 142 may be an interactive display, which may receive, detect, or capture input, such as user input representing user interaction with the image capture apparatus 100. The image capture apparatus 100 may include multiple displays structured on respective surfaces of the body 102, such as the displays 108, 142 shown in FIGS. 1A-1B. In some implementations, the display 142 may be omitted or combined with another component of the image capture apparatus 100.

The image capture apparatus 100 may include features or components other than those described herein, such as other buttons or interface features. In some implementations, interchangeable lenses, cold shoes, and hot shoes, or a combination thereof, may be coupled to or combined with the image capture apparatus 100. For example, the image capture apparatus 100 may communicate with an external device, such as an external user interface device, via a wired or wireless computing communication link, such as via the data interface 124. The computing communication link may be a direct computing communication link or an indirect computing communication link, such as a link including another device or a network, such as the Internet. The image capture apparatus 100 may transmit images to the external device via the computing communication link.

The external device may store, process, display, or combination thereof, the images. The external user interface device may be a computing device, such as a smartphone, a tablet computer, a smart watch, a portable computer, personal computing device, or another device or combination of devices configured to receive user input, communicate information with the image capture apparatus 100 via the computing communication link, or receive user input and communicate information with the image capture apparatus 100 via the computing communication link. The external user interface device may implement or execute one or more applications to manage or control the image capture apparatus 100. For example, the external user interface device may include an application for controlling camera configuration, video acquisition, video display, or any other configurable or controllable aspect of the image capture apparatus 100. In some implementations, the external user interface device may generate and share, such as via a cloud-based or social media service, one or more images or video clips. In some implementations, the external user interface device may display unprocessed or minimally processed images or video captured by the image capture apparatus 100 contemporaneously with capturing the images or video by the image capture apparatus 100, such as for shot framing or live preview.

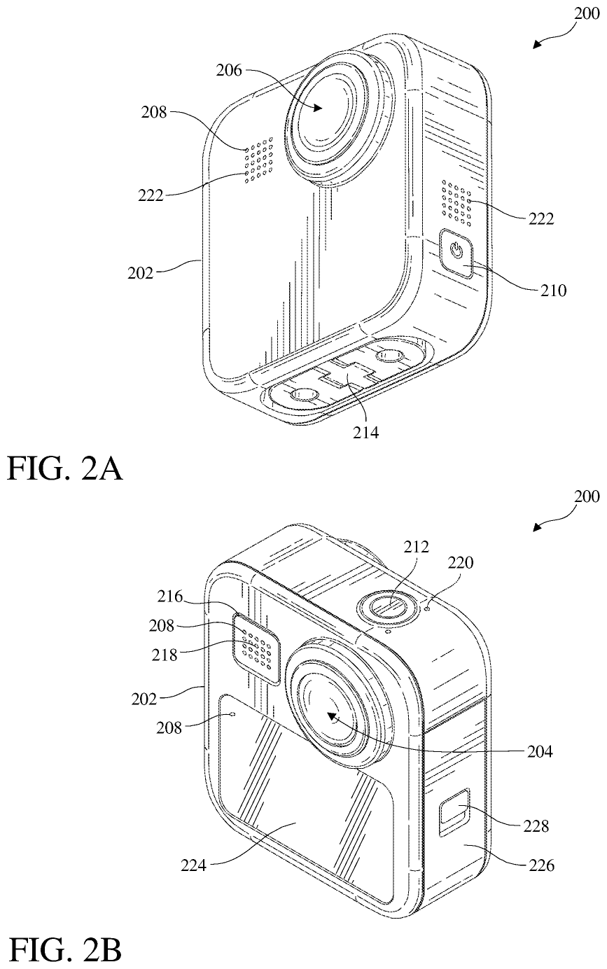

FIGS. 2A-2B illustrate another example of an image capture apparatus 200. The image capture apparatus 200 is similar to the image capture apparatus 100 shown in FIGS. 1A-1B. The image capture apparatus 200 includes a body 202, a first image capture device 204, a second image capture device 206, indicators 208, a mode button 210, a shutter button 212, an interconnect mechanism 214, a drainage channel 216, audio components 218, 220, 222, a display 224, and a door 226 including a release mechanism 228. The arrangement of the components of the image capture apparatus 200 shown in FIGS. 2A-2B is an example, other arrangements of elements may be used.

The body 202 of the image capture apparatus 200 may be similar to the body 102 shown in FIGS. 1A-1B. The first image capture device 204 is structured on a front surface of the body 202. The first image capture device 204 includes a first lens. The first image capture device 204 may be similar to the image capture device 104 shown in FIG. 1A. As shown in FIG. 2A, the image capture apparatus 200 includes the second image capture device 206 structured on a rear surface of the body 202. The second image capture device 206 includes a second lens. The second image capture device 206 may be similar to the image capture device 104 shown in FIG. 1A. The image capture devices 204, 206 are disposed on opposing surfaces of the body 202, for example, in a back-to-back configuration, Janus configuration, or offset Janus configuration. The image capture apparatus 200 may include other image capture devices structured on respective surfaces of the body 202.

As shown in FIG. 2B, the image capture apparatus 200 includes the indicators 208 associated with the audio component 218 and the display 224 on the front surface of the body 202. The indicators 208 may be similar to the indicator 106 shown in FIG. 1A. For example, one of the indicators 208 may indicate a status of the first image capture device 204 and another one of the indicators 208 may indicate a status of the second image capture device 206. Although two indicators 208 are shown in FIGS. 2A-2B, the image capture apparatus 200 may include other indictors structured on respective surfaces of the body 202.

As shown in FIGS. 2A-2B, the image capture apparatus 200 includes input mechanisms including the mode button 210, structured on a side surface of the body 202, and the shutter button 212, structured on a top surface of the body 202. The mode button 210 may be similar to the mode button 110 shown in FIG. 1B. The shutter button 212 may be similar to the shutter button 112 shown in FIG. 1A.

The image capture apparatus 200 includes internal electronics (not expressly shown), such as imaging electronics, power electronics, and the like, internal to the body 202 for capturing images and performing other functions of the image capture apparatus 200. An example showing internal electronics is shown in FIG. 5.

As shown in FIGS. 2A-2B, the image capture apparatus 200 includes the interconnect mechanism 214 structured on a bottom surface of the body 202. The interconnect mechanism 214 may be similar to the interconnect mechanism 140 shown in FIG. 1B.

As shown in FIG. 2B, the image capture apparatus 200 includes the drainage channel 216 for draining liquid from audio components of the image capture apparatus 200.

As shown in FIGS. 2A-2B, the image capture apparatus 200 includes the audio components 218, 220, 222, respectively structured on respective surfaces of the body 202. The audio components 218, 220, 222 may be similar to the microphones 128, 130, 132 and the speaker 138 shown in FIGS. 1A-1B. One or more of the audio components 218, 220, 222 may be, or may include, audio sensors, such as microphones, to receive and record audio signals, such as voice commands or other audio, in conjunction with capturing images or video. One or more of the audio components 218, 220, 222 may be, or may include, an audio presentation component that may present, or play, audio, such as to provide notifications or alerts.

As shown in FIGS. 2A-2B, a first audio component 218 is located on a front surface of the body 202, a second audio component 220 is located on a top surface of the body 202, and a third audio component 222 is located on a back surface of the body 202. Other numbers and configurations for the audio components 218, 220, 222 may be used. For example, the audio component 218 may be a drain microphone surrounded by the drainage channel 216 and adjacent to one of the indicators 208 as shown in FIG. 2B.

As shown in FIG. 2B, the image capture apparatus 200 includes the display 224 structured on a front surface of the body 202. The display 224 may be similar to the displays 108, 142 shown in FIGS. 1A-1B. The display 224 may include an I/O interface. The display 224 may include one or more of the indicators 208. The display 224 may receive touch inputs. The display 224 may display image information during video capture. The display 224 may provide status information to a user, such as status information indicating battery power level, memory card capacity, time elapsed for a recorded video, etc. The image capture apparatus 200 may include multiple displays structured on respective surfaces of the body 202. In some implementations, the display 224 may be omitted or combined with another component of the image capture apparatus 200.

As shown in FIG. 2B, the image capture apparatus 200 includes the door 226 structured on, or forming a portion of, the side surface of the body 202. The door 226 may be similar to the door 114 shown in FIG. 1A. For example, the door 226 shown in FIG. 2A includes a release mechanism 228. The release mechanism 228 may include a latch, a button, or other mechanism configured to receive a user input that allows the door 226 to change position. The release mechanism 228 may be used to open the door 226 for a user to access a battery, a battery receptacle, an I/O interface, a memory card interface, etc.

In some embodiments, the image capture apparatus 200 may include features or components other than those described herein, some features or components described herein may be omitted, or some features or components described herein may be combined. For example, the image capture apparatus 200 may include additional interfaces or different interface features, interchangeable lenses, cold shoes, or hot shoes.

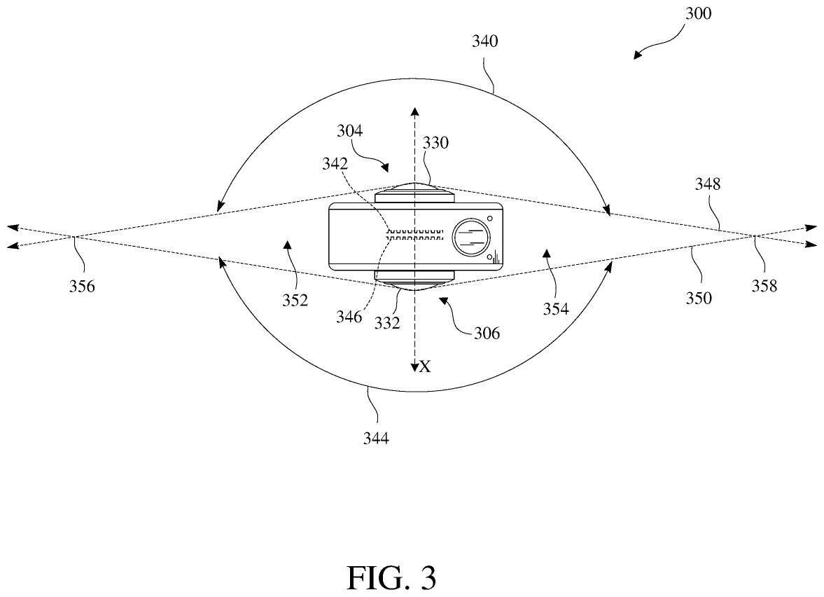

FIG. 3 is a top view of an image capture apparatus 300. The image capture apparatus 300 is similar to the image capture apparatus 200 of FIGS. 2A-2B and is configured to capture spherical images.

As shown in FIG. 3, a first image capture device 304 includes a first lens 330 and a second image capture device 306 includes a second lens 332. For example, the first image capture device 304 may capture a first image, such as a first hemispheric, or hyper-hemispherical, image, the second image capture device 306 may capture a second image, such as a second hemispheric, or hyper-hemispherical, image, and the image capture apparatus 300 may generate a spherical image incorporating or combining the first image and the second image, which may be captured concurrently, or substantially concurrently.

The first image capture device 304 defines a first field-of-view 340 wherein the first lens 330 of the first image capture device 304 receives light. The first lens 330 directs the received light corresponding to the first field-of-view 340 onto a first image sensor 342 of the first image capture device 304. For example, the first image capture device 304 may include a first lens barrel (not expressly shown), extending from the first lens 330 to the first image sensor 342.

The second image capture device 306 defines a second field-of-view 344 wherein the second lens 332 receives light. The second lens 332 directs the received light corresponding to the second field-of-view 344 onto a second image sensor 346 of the second image capture device 306. For example, the second image capture device 306 may include a second lens barrel (not expressly shown), extending from the second lens 332 to the second image sensor 346.

A boundary 348 of the first field-of-view 340 is shown using broken directional lines. A boundary 350 of the second field-of-view 344 is shown using broken directional lines. As shown, the image capture devices 304, 306 are arranged in a back-to-back (Janus) configuration such that the lenses 330, 332 face in opposite directions, and such that the image capture apparatus 300 may capture spherical images. The first image sensor 342 captures a first hyper-hemispherical image plane from light entering the first lens 330. The second image sensor 346 captures a second hyper-hemispherical image plane from light entering the second lens 332.

As shown in FIG. 3, the fields-of-view 340, 344 partially overlap such that the combination of the fields-of-view 340, 344 forms a spherical field-of-view, except that one or more uncaptured areas 352, 354 may be outside of the fields-of-view 340, 344 of the lenses 330, 332. Light emanating from or passing through the uncaptured areas 352, 354, which may be proximal to the image capture apparatus 300, may be obscured from the lenses 330, 332 and the corresponding image sensors 342, 346, such that content corresponding to the uncaptured areas 352, 354 may be omitted from images captured by the image capture apparatus 300. In some implementations, the image capture devices 304, 306, or the lenses 330, 332 thereof, may be configured to minimize the uncaptured areas 352, 354.

Examples of points of transition, or overlap points, from the uncaptured areas 352, 354 to the overlapping portions of the fields-of-view 340, 344 are shown at 356, 358.

Images contemporaneously captured by the respective image sensors 342, 346 may be combined to form a combined image, such as a spherical image. Generating a combined image may include correlating the overlapping regions captured by the respective image sensors 342, 346, aligning the captured fields-of-view 340, 344, and stitching the images together to form a cohesive combined image. Stitching the images together may include correlating the overlap points 356, 358 with respective locations in corresponding images captured by the image sensors 342, 346. Although a planar view of the fields-of-view 340, 344 is shown in FIG. 3, the fields-of-view 340, 344 are hyper-hemispherical.

A change in the alignment, such as position, tilt, or a combination thereof, of the image capture devices 304, 306, such as of the lenses 330, 332, the image sensors 342, 346, or both, may change the relative positions of the respective fields-of-view 340, 344, may change the locations of the overlap points 356, 358, such as with respect to images captured by the image sensors 342, 346, and may change the uncaptured areas 352, 354, which may include changing the uncaptured areas 352, 354 unequally.

Incomplete or inaccurate information indicating the alignment of the image capture devices 304, 306, such as the locations of the overlap points 356, 358, may decrease the accuracy, efficiency, or both of generating a combined image. In some implementations, the image capture apparatus 300 may maintain information indicating the location and orientation of the image capture devices 304, 306, such as of the lenses 330, 332, the image sensors 342, 346, or both, such that the fields-of-view 340, 344, the overlap points 356, 358, or both may be accurately determined, which may improve the accuracy, efficiency, or both of generating a combined image.

The lenses 330, 332 may be aligned along an axis X as shown, laterally offset from each other (not shown), off-center from a central axis of the image capture apparatus 300 (not shown), or laterally offset and off-center from the central axis (not shown). Whether through use of offset or through use of compact image capture devices 304, 306, a reduction in distance between the lenses 330, 332 along the axis X may improve the overlap in the fields-of-view 340, 344, such as by reducing the uncaptured areas 352, 354.

Images or frames captured by the image capture devices 304, 306 may be combined, merged, or stitched together to produce a combined image, such as a spherical or panoramic image, which may be an equirectangular planar image. In some implementations, generating a combined image may include use of techniques such as noise reduction, tone mapping, white balancing, or other image correction. In some implementations, pixels along a stitch boundary, which may correspond with the overlap points 356, 358, may be matched accurately to minimize boundary discontinuities.

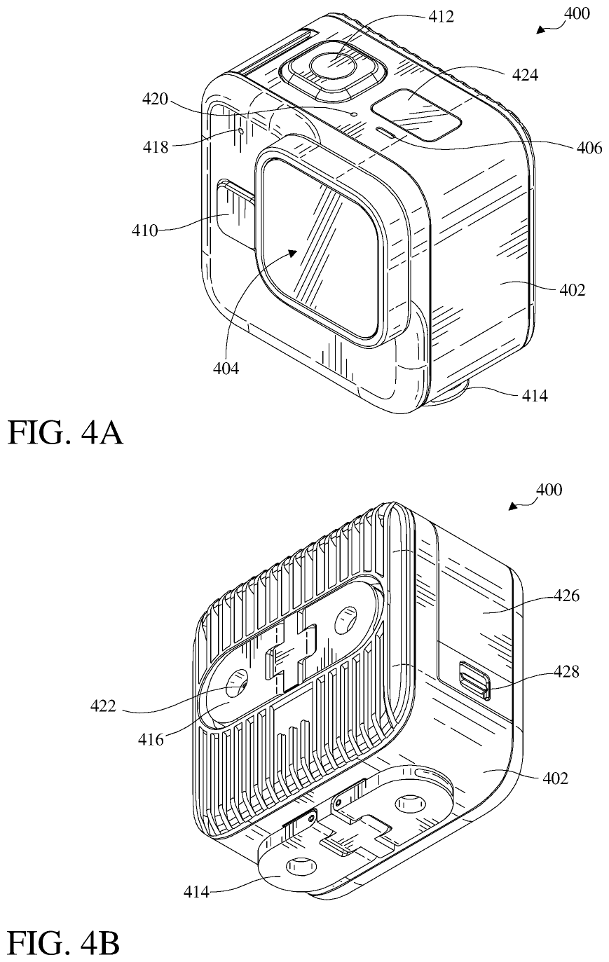

FIGS. 4A-4B illustrate another example of an image capture apparatus 400. The image capture apparatus 400 is similar to the image capture apparatus 100 shown in FIGS. 1A-1B and to the image capture apparatus 200 shown in FIGS. 2A-2B. The image capture apparatus 400 includes a body 402, an image capture device 404, an indicator 406, a mode button 410, a shutter button 412, interconnect mechanisms 414, 416, audio components 418, 420, 422, a display 424, and a door 426 including a release mechanism 428. The arrangement of the components of the image capture apparatus 400 shown in FIGS. 4A-4B is an example, other arrangements of elements may be used.

The body 402 of the image capture apparatus 400 may be similar to the body 102 shown in FIGS. 1A-1B. The image capture device 404 is structured on a front surface of the body 402. The image capture device 404 includes a lens and may be similar to the image capture device 104 shown in FIG. 1A.

As shown in FIG. 4A, the image capture apparatus 400 includes the indicator 406 on a top surface of the body 402. The indicator 406 may be similar to the indicator 106 shown in FIG. 1A. The indicator 406 may indicate a status of the image capture device 204. Although one indicator 406 is shown in FIGS. 4A, the image capture apparatus 400 may include other indictors structured on respective surfaces of the body 402.

As shown in FIGS. 4A, the image capture apparatus 400 includes input mechanisms including the mode button 410, structured on a front surface of the body 402, and the shutter button 412, structured on a top surface of the body 402. The mode button 410 may be similar to the mode button 110 shown in FIG. 1B. The shutter button 412 may be similar to the shutter button 112 shown in FIG. 1A.

The image capture apparatus 400 includes internal electronics (not expressly shown), such as imaging electronics, power electronics, and the like, internal to the body 402 for capturing images and performing other functions of the image capture apparatus 400. An example showing internal electronics is shown in FIG. 5.

As shown in FIGS. 4A-4B, the image capture apparatus 400 includes the interconnect mechanisms 414, 416, with a first interconnect mechanism 414 structured on a bottom surface of the body 402 and a second interconnect mechanism 416 disposed within a rear surface of the body 402. The interconnect mechanisms 414, 416 may be similar to the interconnect mechanism 140 shown in FIG. 1B and the interconnect mechanism 214 shown in FIG. 2A.

As shown in FIGS. 4A-4B, the image capture apparatus 400 includes the audio components 418, 420, 422 respectively structured on respective surfaces of the body 402. The audio components 418, 420, 422 may be similar to the microphones 128, 130, 132 and the speaker 138 shown in FIGS. 1A-1B. One or more of the audio components 418, 420, 422 may be, or may include, audio sensors, such as microphones, to receive and record audio signals, such as voice commands or other audio, in conjunction with capturing images or video. One or more of the audio components 418, 420, 422 may be, or may include, an audio presentation component that may present, or play, audio, such as to provide notifications or alerts.

As shown in FIGS. 4A-4B, a first audio component 418 is located on a front surface of the body 402, a second audio component 420 is located on a top surface of the body 402, and a third audio component 422 is located on a rear surface of the body 402. Other numbers and configurations for the audio components 418, 420, 422 may be used.

As shown in FIG. 4A, the image capture apparatus 400 includes the display 424 structured on a front surface of the body 402. The display 424 may be similar to the displays 108, 142 shown in FIGS. 1A-1B. The display 424 may include an I/O interface. The display 424 may receive touch inputs. The display 424 may display image information during video capture. The display 424 may provide status information to a user, such as status information indicating battery power level, memory card capacity, time elapsed for a recorded video, etc. The image capture apparatus 400 may include multiple displays structured on respective surfaces of the body 402. In some implementations, the display 424 may be omitted or combined with another component of the image capture apparatus 200.

As shown in FIG. 4B, the image capture apparatus 400 includes the door 426 structured on, or forming a portion of, the side surface of the body 402. The door 426 may be similar to the door 226 shown in FIG. 2B. The door 426 shown in FIG. 4B includes the release mechanism 428. The release mechanism 428 may include a latch, a button, or other mechanism configured to receive a user input that allows the door 426 to change position. The release mechanism 428 may be used to open the door 426 for a user to access a battery, a battery receptacle, an I/O interface, a memory card interface, etc.

In some embodiments, the image capture apparatus 400 may include features or components other than those described herein, some features or components described herein may be omitted, or some features or components described herein may be combined. For example, the image capture apparatus 400 may include additional interfaces or different interface features, interchangeable lenses, cold shoes, or hot shoes.

FIG. 5 is a block diagram of electronic components in an image capture apparatus 500. The image capture apparatus 500 may be a single-lens image capture device, a multi-lens image capture device, or variations thereof, including an image capture apparatus with multiple capabilities such as the use of interchangeable integrated sensor lens assemblies. Components, such as electronic components, of the image capture apparatus 100 shown in FIGS. 1A-1B, the image capture apparatus 200 shown in FIGS. 2A-2B, the image capture apparatus 300 shown in FIG. 3, or the image capture apparatus 400 shown in FIGS. 4A-4B, may be implemented as shown in FIG. 5.

The image capture apparatus 500 includes a body 502. The body 502 may be similar to the body 102 shown in FIGS. 1A-1B, the body 202 shown in FIGS. 2A-2B, or the body 402 shown in FIGS. 4A-4B. The body 502 includes electronic components such as capture components 510, processing components 520, data interface components 530, spatial sensors 540, power components 550, user interface components 560, and a bus 580.

The capture components 510 include an image sensor 512 for capturing images. Although one image sensor 512 is shown in FIG. 5, the capture components 510 may include multiple image sensors. The image sensor 512 may be similar to the image sensors 342, 346 shown in FIG. 3. The image sensor 512 may be, for example, a charge-coupled device (CCD) sensor, an active pixel sensor (APS), a complementary metal-oxide-semiconductor (CMOS) sensor, or an N-type metal-oxide-semiconductor (NMOS) sensor. The image sensor 512 detects light, such as within a defined spectrum, such as the visible light spectrum or the infrared spectrum, incident through a corresponding lens such as the first lens 330 with respect to the first image sensor 342 or the second lens 332 with respect to the second image sensor 346 as shown in FIG. 3. The image sensor 512 captures detected light as image data and conveys the captured image data as electrical signals (image signals or image data) to the other components of the image capture apparatus 500, such as to the processing components 520, such as via the bus 580.

The capture components 510 include a microphone 514 for capturing audio. Although one microphone 514 is shown in FIG. 5, the capture components 510 may include multiple microphones. The microphone 514 detects and captures, or records, sound, such as sound waves incident upon the microphone 514. The microphone 514 may detect, capture, or record sound in conjunction with capturing images by the image sensor 512. The microphone 514 may detect sound to receive audible commands to control the image capture apparatus 500. The microphone 514 may be similar to the microphones 128, 130, 132 shown in FIGS. 1A-1B, the audio components 218, 220, 222 shown in FIGS. 2A-2B, or the audio components 418, 420, 422 shown in FIGS. 4A-4B.

The processing components 520 perform image signal processing, such as filtering, tone mapping, or stitching, to generate, or obtain, processed images, or processed image data, based on image data obtained from the image sensor 512. The processing components 520 may include one or more processors having single or multiple processing cores. In some implementations, the processing components 520 may include, or may be, an application specific integrated circuit (ASIC) or a digital signal processor (DSP). For example, the processing components 520 may include a custom image signal processor. The processing components 520 conveys data, such as processed image data, with other components of the image capture apparatus 500 via the bus 580. In some implementations, the processing components 520 may include an encoder, such as an image or video encoder that may encode, decode, or both, the image data, such as for compression coding, transcoding, or a combination thereof.

Although not shown expressly in FIG. 5, the processing components 520 may include memory, such as a random-access memory (RAM) device, which may be non-transitory computer-readable memory. The memory of the processing components 520 may include executable instructions and data that can be accessed by the processing components 520.

The data interface components 530 communicates with other, such as external, electronic devices, such as a remote control, a smartphone, a tablet computer, a laptop computer, a desktop computer, or an external computer storage device. For example, the data interface components 530 may receive commands to operate the image capture apparatus 500. In another example, the data interface components 530 may transmit image data to transfer the image data to other electronic devices. The data interface components 530 may be configured for wired communication, wireless communication, or both. As shown, the data interface components 530 include an I/O interface 532, a wireless data interface 534, and a storage interface 536. In some implementations, one or more of the I/O interface 532, the wireless data interface 534, or the storage interface 536 may be omitted or combined.

The I/O interface 532 may send, receive, or both, wired electronic communications signals. For example, the I/O interface 532 may be a universal serial bus (USB) interface, such as USB type-C interface, a high-definition multimedia interface (HDMI), a FireWire interface, a digital video interface link, a display port interface link, a Video Electronics Standards Associated (VESA) digital display interface link, an Ethernet link, or a Thunderbolt link. Although one I/O interface 532 is shown in FIG. 5, the data interface components 530 include multiple I/O interfaces. The I/O interface 532 may be similar to the data interface 124 shown in FIG. 1B.

The wireless data interface 534 may send, receive, or both, wireless electronic communications signals. The wireless data interface 534 may be a Bluetooth interface, a ZigBee interface, a Wi-Fi interface, an infrared link, a cellular link, a near field communications (NFC) link, or an Advanced Network Technology interoperability (ANT+) link. Although one wireless data interface 534 is shown in FIG. 5, the data interface components 530 include multiple wireless data interfaces. The wireless data interface 534 may be similar to the data interface 124 shown in FIG. 1B.

The storage interface 536 may include a memory card connector, such as a memory card receptacle, configured to receive and operatively couple to a removable storage device, such as a memory card, and to transfer, such as read, write, or both, data between the image capture apparatus 500 and the memory card, such as for storing images, recorded audio, or both captured by the image capture apparatus 500 on the memory card. Although one storage interface 536 is shown in FIG. 5, the data interface components 530 include multiple storage interfaces. The storage interface 536 may be similar to the data interface 124 shown in FIG. 1B.

The spatial, or spatiotemporal, sensors 540 detect the spatial position, movement, or both, of the image capture apparatus 500. As shown in FIG. 5, the spatial sensors 540 include a position sensor 542, an accelerometer 544, and a gyroscope 546. The position sensor 542, which may be a global positioning system (GPS) sensor, may determine a geospatial position of the image capture apparatus 500, which may include obtaining, such as by receiving, temporal data, such as via a GPS signal. The accelerometer 544, which may be a three-axis accelerometer, may measure linear motion, linear acceleration, or both of the image capture apparatus 500. The gyroscope 546, which may be a three-axis gyroscope, may measure rotational motion, such as a rate of rotation, of the image capture apparatus 500. In some implementations, the spatial sensors 540 may include other types of spatial sensors. In some implementations, one or more of the position sensor 542, the accelerometer 544, and the gyroscope 546 may be omitted or combined.

The power components 550 distribute electrical power to the components of the image capture apparatus 500 for operating the image capture apparatus 500. As shown in FIG. 5, the power components 550 include a battery interface 552, a battery 554, and an external power interface 556 (ext. interface). The battery interface 552 (bat. interface) operatively couples to the battery 554, such as via conductive contacts to transfer power from the battery 554 to the other electronic components of the image capture apparatus 500. The battery interface 552 may be similar to the battery receptacle 126 shown in FIG. 1B. The external power interface 556 obtains or receives power from an external source, such as a wall plug or external battery, and distributes the power to the components of the image capture apparatus 500, which may include distributing power to the battery 554 via the battery interface 552 to charge the battery 554. Although one battery interface 552, one battery 554, and one external power interface 556 are shown in FIG. 5, any number of battery interfaces, batteries, and external power interfaces may be used. In some implementations, one or more of the battery interface 552, the battery 554, and the external power interface 556 may be omitted or combined. For example, in some implementations, the external interface 556 and the I/O interface 532 may be combined.

The user interface components 560 receive input, such as user input, from a user of the image capture apparatus 500, output, such as display or present, information to a user, or both receive input and output information, such as in accordance with user interaction with the image capture apparatus 500.

As shown in FIG. 5, the user interface components 560 include visual output components 562 to visually communicate information, such as to present captured images. As shown, the visual output components 562 include an indicator 564 and a display 566. The indicator 564 may be similar to the indicator 106 shown in FIG. 1A, the indicators 208 shown in FIGS. 2A-2B, or the indicator 406 shown in FIG. 4A. The display 566 may be similar to the display 108 shown in FIG. 1A, the display 142 shown in FIG. 1B, the display 224 shown in FIG. 2B, or the display 424 shown in FIG. 4A. Although the visual output components 562 are shown in FIG. 5 as including one indicator 564, the visual output components 562 may include multiple indicators. Although the visual output components 562 are shown in FIG. 5 as including one display 566, the visual output components 562 may include multiple displays. In some implementations, one or more of the indicator 564 or the display 566 may be omitted or combined.

As shown in FIG. 5, the user interface components 560 include a speaker 568. The speaker 568 may be similar to the speaker 138 shown in FIG. 1B, the audio components 218, 220, 222 shown in FIGS. 2A-2B, or the audio components 418, 420, 422 shown in FIGS. 4A-4B. Although one speaker 568 is shown in FIG. 5, the user interface components 560 may include multiple speakers. In some implementations, the speaker 568 may be omitted or combined with another component of the image capture apparatus 500, such as the microphone 514.

As shown in FIG. 5, the user interface components 560 include a physical input interface 570. The physical input interface 570 may be similar to the mode buttons 110, 210, 410 shown in FIGS. 1A, 2A, and 4A or the shutter buttons 112, 212, 412 shown in FIGS. 1A, 2B, and 4A. Although one physical input interface 570 is shown in FIG. 5, the user interface components 560 may include multiple physical input interfaces. In some implementations, the physical input interface 570 may be omitted or combined with another component of the image capture apparatus 500. The physical input interface 570 may be, for example, a button, a toggle, a switch, a dial, or a slider.

As shown in FIG. 5, the user interface components 560 include a broken line border box labeled “other” to indicate that components of the image capture apparatus 500 other than the components expressly shown as included in the user interface components 560 may be user interface components. For example, the microphone 514 may receive, or capture, and process audio signals to obtain input data, such as user input data corresponding to voice commands. In another example, the image sensor 512 may receive, or capture, and process image data to obtain input data, such as user input data corresponding to visible gesture commands. In another example, one or more of the spatial sensors 540, such as a combination of the accelerometer 544 and the gyroscope 546, may receive, or capture, and process motion data to obtain input data, such as user input data corresponding to motion gesture commands.

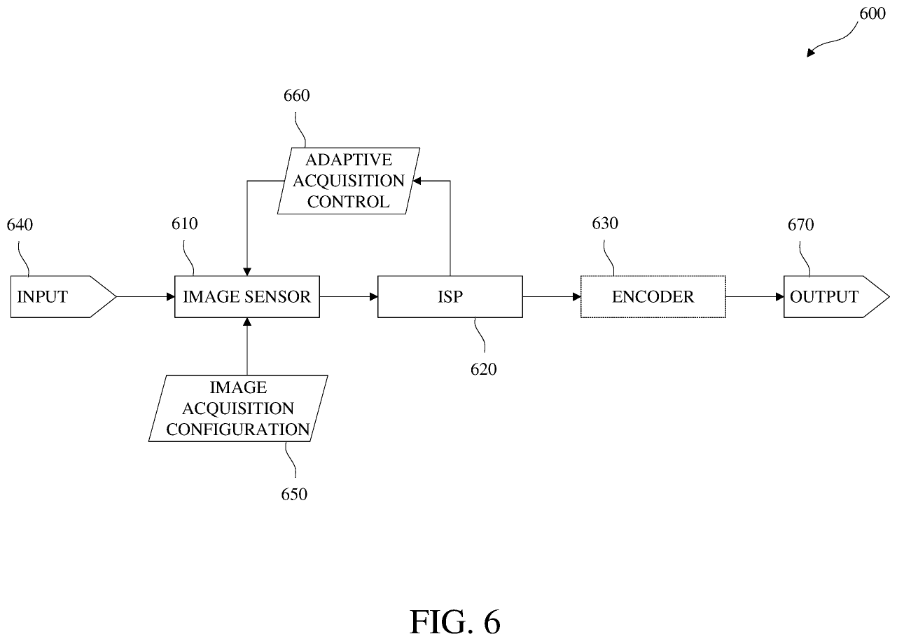

FIG. 6 is a block diagram of an example of an image processing pipeline 600. The image processing pipeline 600, or a portion thereof, is implemented in an image capture apparatus, such as the image capture apparatus 100 shown in FIGS. 1A-1B, the image capture apparatus 200 shown in FIGS. 2A-2B, the image capture apparatus 300 shown in FIG. 3, the image capture apparatus 400 shown in FIGS. 4A-4B, or another image capture apparatus. In some implementations, the image processing pipeline 600 may be implemented in a digital signal processor (DSP), an application-specific integrated circuit (ASIC), or a combination of a digital signal processor and an application-specific integrated circuit. One or more components of the pipeline 600 may be implemented in hardware, software, or a combination of hardware and software.

As shown in FIG. 6, the image processing pipeline 600 includes an image sensor 610, an image signal processor (ISP) 620, and an encoder 630. The encoder 630 is shown with a broken line border to indicate that the encoder may be omitted, or absent, from the image processing pipeline 600. In some implementations, the encoder 630 may be included in another device. In implementations that include the encoder 630, the image processing pipeline 600 may be an image processing and coding pipeline. The image processing pipeline 600 may include components other than the components shown in FIG. 6.

The image sensor 610 receives input 640, such as photons incident on the image sensor 610. The image sensor 610 captures image data (source image data). Capturing source image data includes measuring or sensing the input 640, which may include counting, or otherwise measuring, photons incident on the image sensor 610, such as for a defined temporal duration or period (exposure). Capturing source image data includes converting the analog input 640 to a digital source image signal in a defined format, which may be referred to herein as “a raw image signal.” For example, the raw image signal may be in a format such as RGB format, which may represent individual pixels using a combination of values or components, such as a red component (R), a green component (G), and a blue component (B). In another example, the raw image signal may be in a Bayer format, wherein a respective pixel may be one of a combination of adjacent pixels, such as a combination of four adjacent pixels, of a Bayer pattern.

Although one image sensor 610 is shown in FIG. 6, the image processing pipeline 600 may include two or more image sensors. In some implementations, an image, or frame, such as an image, or frame, included in the source image signal, may be one of a sequence or series of images or frames of a video, such as a sequence, or series, of frames captured at a rate, or frame rate, which may be a number or cardinality of frames captured per defined temporal period, such as twenty-four, thirty, sixty, or one-hundred twenty frames per second.

The image sensor 610 obtains image acquisition configuration data 650. The image acquisition configuration data 650 may include image cropping parameters, binning/skipping parameters, pixel rate parameters, bitrate parameters, resolution parameters, framerate parameters, or other image acquisition configuration data or combinations of image acquisition configuration data. Obtaining the image acquisition configuration data 650 may include receiving the image acquisition configuration data 650 from a source other than a component of the image processing pipeline 600. For example, the image acquisition configuration data 650, or a portion thereof, may be received from another component, such as a user interface component, of the image capture apparatus implementing the image processing pipeline 600, such as one or more of the user interface components 560 shown in FIG. 5. The image sensor 610 obtains, outputs, or both, the source image data in accordance with the image acquisition configuration data 650. For example, the image sensor 610 may obtain the image acquisition configuration data 650 prior to capturing the source image.

The image sensor 610 receives, or otherwise obtains or accesses, adaptive acquisition control data 660, such as auto exposure (AE) data, auto white balance (AWB) data, global tone mapping (GTM) data, Auto Color Lens Shading (ACLS) data, color correction data, or other adaptive acquisition control data or combination of adaptive acquisition control data. For example, the image sensor 610 receives the adaptive acquisition control data 660 from the image signal processor 620. The image sensor 610 obtains, outputs, or both, the source image data in accordance with the adaptive acquisition control data 660.

The image sensor 610 controls, such as configures, sets, or modifies, one or more image acquisition parameters or settings, or otherwise controls the operation of the image signal processor 620, in accordance with the image acquisition configuration data 650 and the adaptive acquisition control data 660. For example, the image sensor 610 may capture a first source image using, or in accordance with, the image acquisition configuration data 650, and in the absence of adaptive acquisition control data 660 or using defined values for the adaptive acquisition control data 660, output the first source image to the image signal processor 620, obtain adaptive acquisition control data 660 generated using the first source image data from the image signal processor 620, and capture a second source image using, or in accordance with, the image acquisition configuration data 650 and the adaptive acquisition control data 660 generated using the first source image. In an example, the adaptive acquisition control data 660 may include an exposure duration value and the image sensor 610 may capture an image in accordance with the exposure duration value.

The image sensor 610 outputs source image data, which may include the source image signal, image acquisition data, or a combination thereof, to the image signal processor 620.

The image signal processor 620 receives, or otherwise accesses or obtains, the source image data from the image sensor 610. The image signal processor 620 processes the source image data to obtain input image data. In some implementations, the image signal processor 620 converts the raw image signal (RGB data) to another format, such as a format expressing individual pixels using a combination of values or components, such as a luminance, or luma, value (Y), a blue chrominance, or chroma, value (U or Cb), and a red chroma value (V or Cr), such as the YUV or YCbCr formats.

Processing the source image data includes generating the adaptive acquisition control data 660. The adaptive acquisition control data 660 includes data for controlling the acquisition of a one or more images by the image sensor 610.

The image signal processor 620 includes components not expressly shown in FIG. 6 for obtaining and processing the source image data. For example, the image signal processor 620 may include one or more sensor input (SEN) components (not shown), one or more sensor readout (SRO) components (not shown), one or more image data compression components, one or more image data decompression components, one or more internal memory, or data storage, components, one or more Bayer-to-Bayer (B2B) components, one or more local motion estimation (LME) components, one or more local motion compensation (LMC) components, one or more global motion compensation (GMC) components, one or more Bayer-to-RGB (B2R) components, one or more image processing units (IPU), one or more high dynamic range (HDR) components, one or more three-dimensional noise reduction (3DNR) components, one or more sharpening components, one or more raw-to-YUV (R2Y) components, one or more Chroma Noise Reduction (CNR) components, one or more local tone mapping (LTM) components, one or more YUV-to-YUV (Y2Y) components, one or more warp and blend components, one or more stitching cost components, one or more scaler components, or a configuration controller. The image signal processor 620, or respective components thereof, may be implemented in hardware, software, or a combination of hardware and software. Although one image signal processor 620 is shown in FIG. 6, the image processing pipeline 600 may include multiple image signal processors. In implementations that include multiple image signal processors, the functionality of the image signal processor 620 may be divided or distributed among the image signal processors.

In some implementations, the image signal processor 620 may implement or include multiple parallel, or partially parallel paths for image processing. For example, for high dynamic range image processing based on two source images, the image signal processor 620 may implement a first image processing path for a first source image and a second image processing path for a second source image, wherein the image processing paths may include components that are shared among the paths, such as memory components, and may include components that are separately included in each path, such as a first sensor readout component in the first image processing path and a second sensor readout component in the second image processing path, such that image processing by the respective paths may be performed in parallel, or partially in parallel.

The image signal processor 620, or one or more components thereof, such as the sensor input components, may perform black-point removal for the image data. In some implementations, the image sensor 610 may compress the source image data, or a portion thereof, and the image signal processor 620, or one or more components thereof, such as one or more of the sensor input components or one or more of the image data decompression components, may decompress the compressed source image data to obtain the source image data.

The image signal processor 620, or one or more components thereof, such as the sensor readout components, may perform dead pixel correction for the image data. The sensor readout component may perform scaling for the image data. The sensor readout component may obtain, such as generate or determine, adaptive acquisition control data, such as auto exposure data, auto white balance data, global tone mapping data, Auto Color Lens Shading data, or other adaptive acquisition control data, based on the source image data.

The image signal processor 620, or one or more components thereof, such as the image data compression components, may obtain the image data, or a portion thereof, such as from another component of the image signal processor 620, compress the image data, and output the compressed image data, such as to another component of the image signal processor 620, such as to a memory component of the image signal processor 620.

The image signal processor 620, or one or more components thereof, such as the image data decompression, or uncompression, components (UCX), may read, receive, or otherwise access, compressed image data and may decompress, or uncompress, the compressed image data to obtain image data. In some implementations, other components of the image signal processor 620 may request, such as send a request message or signal, the image data from an uncompression component, and, in response to the request, the uncompression component may obtain corresponding compressed image data, uncompress the compressed image data to obtain the requested image data, and output, such as send or otherwise make available, the requested image data to the component that requested the image data. The image signal processor 620 may include multiple uncompression components, which may be respectively optimized for uncompression with respect to one or more defined image data formats.

The image signal processor 620, or one or more components thereof, such as the internal memory, or data storage, components. The memory components store image data, such as compressed image data internally within the image signal processor 620 and are accessible to the image signal processor 620, or to components of the image signal processor 620. In some implementations, a memory component may be accessible, such as write accessible, to a defined component of the image signal processor 620, such as an image data compression component, and the memory component may be accessible, such as read accessible, to another defined component of the image signal processor 620, such as an uncompression component of the image signal processor 620.

The image signal processor 620, or one or more components thereof, such as the Bayer-to-Bayer components, which may process image data, such as to transform or convert the image data from a first Bayer format, such as a signed 15-bit Bayer format data, to second Bayer format, such as an unsigned 14-bit Bayer format. The Bayer-to-Bayer components may obtain, such as generate or determine, high dynamic range Tone Control data based on the current image data.

Although not expressly shown in FIG. 6, in some implementations, a respective Bayer-to-Bayer component may include one or more sub-components. For example, the Bayer-to-Bayer component may include one or more gain components. In another example, the Bayer-to-Bayer component may include one or more offset map components, which may respectively apply respective offset maps to the image data. The respective offset maps may have a configurable size, which may have a maximum size, such as 129×129. The respective offset maps may have a non-uniform grid. Applying the offset map may include saturation management, which may preserve saturated areas on respective images based on R, G, and B values. The values of the offset map may be modified per-frame and double buffering may be used for the map values. A respective offset map component may, such as prior to Bayer noise removal (denoising), compensate for non-uniform black point removal, such as due to non-uniform thermal heating of the sensor or image capture device. A respective offset map component may, such as subsequent to Bayer noise removal, compensate for flare, such as flare on hemispherical lenses, and/or may perform local contrast enhancement, such a dehazing or local tone mapping.

In another example, the Bayer-to-Bayer component may include a Bayer Noise Reduction (Bayer NR) component, which may convert image data, such as from a first format, such as a signed 15-bit Bayer format, to a second format, such as an unsigned 14-bit Bayer format. In another example, the Bayer-to-Bayer component may include one or more lens shading (FSHD) component, which may, respectively, perform lens shading correction, such as luminance lens shading correction, color lens shading correction, or both. In some implementations, a respective lens shading component may perform exposure compensation between two or more sensors of a multi-sensor image capture apparatus, such as between two hemispherical lenses. In some implementations, a respective lens shading component may apply map-based gains, radial model gain, or a combination, such as a multiplicative combination, thereof. In some implementations, a respective lens shading component may perform saturation management, which may preserve saturated areas on respective images. Map and lookup table values for a respective lens shading component may be configured or modified on a per-frame basis and double buffering may be used.

In another example, the Bayer-to-Bayer component may include a PZSFT component. In another example, the Bayer-to-Bayer component may include a half-RGB (½ RGB) component. In another example, the Bayer-to-Bayer component may include a color correction (CC) component, which may obtain subsampled data for local tone mapping, which may be used, for example, for applying an unsharp mask. In another example, the Bayer-to-Bayer component may include a Tone Control (TC) component, which may obtain subsampled data for local tone mapping, which may be used, for example, for applying an unsharp mask. In another example, the Bayer-to-Bayer component may include a Gamma (GM) component, which may apply a lookup-table independently per channel for color rendering (gamma curve application). Using a lookup-table, which may be an array, may reduce resource utilization, such as processor utilization, using an array indexing operation rather than more complex computation. The gamma component may obtain subsampled data for local tone mapping, which may be used, for example, for applying an unsharp mask.

In another example, the Bayer-to-Bayer component may include an RGB binning (RGB BIN) component, which may include a configurable binning factor, such as a binning factor configurable in the range from four to sixteen, such as four, eight, or sixteen. One or more sub-components of the Bayer-to-Bayer component, such as the RGB Binning component and the half-RGB component, may operate in parallel. The RGB binning component may output image data, such as to an external memory, which may include compressing the image data. The output of the RGB binning component may be a binned image, which may include low-resolution image data or low-resolution image map data. The output of the RGB binning component may be used to extract statistics for combing images, such as combining hemispherical images. The output of the RGB binning component may be used to estimate flare on one or more lenses, such as hemispherical lenses. The RGB binning component may obtain G channel values for the binned image by averaging Gr channel values and Gb channel values. The RGB binning component may obtain one or more portions of or values for the binned image by averaging pixel values in spatial areas identified based on the binning factor. In another example, the Bayer-to-Bayer component may include, such as for spherical image processing, an RGB-to-YUV component, which may obtain tone mapping statistics, such as histogram data and thumbnail data, using a weight map, which may weight respective regions of interest prior to statistics aggregation.

The image signal processor 620, or one or more components thereof, such as the local motion estimation components, which may generate local motion estimation data for use in image signal processing and encoding, such as in correcting distortion, stitching, and/or motion compensation. For example, the local motion estimation components may partition an image into blocks, arbitrarily shaped patches, individual pixels, or a combination thereof. The local motion estimation components may compare pixel values between frames, such as successive images, to determine displacement, or movement, between frames, which may be expressed as motion vectors (local motion vectors).

The image signal processor 620, or one or more components thereof, such as the local motion compensation components, which may obtain local motion data, such as local motion vectors, and may spatially apply the local motion data to an image to obtain a local motion compensated image or frame and may output the local motion compensated image or frame to one or more other components of the image signal processor 620.

The image signal processor 620, or one or more components thereof, such as the global motion compensation components, may receive, or otherwise access, global motion data, such as global motion data from a gyroscopic unit of the image capture apparatus, such as the gyroscope 546 shown in FIG. 5, corresponding to the current frame. The global motion compensation component may apply the global motion data to a current image to obtain a global motion compensated image, which the global motion compensation component may output, or otherwise make available, to one or more other components of the image signal processor 620.

The image signal processor 620, or one or more components thereof, such as the Bayer-to-RGB components, which convert the image data from Bayer format to an RGB format. The Bayer-to-RGB components may implement white balancing and demosaicing. The Bayer-to-RGB components respectively output, or otherwise make available, RGB format image data to one or more other components of the image signal processor 620.

The image signal processor 620, or one or more components thereof, such as the image processing units, which perform warping, image registration, electronic image stabilization, motion detection, object detection, or the like. The image processing units respectively output, or otherwise make available, processed, or partially processed, image data to one or more other components of the image signal processor 620.

The image signal processor 620, or one or more components thereof, such as the high dynamic range components, may, respectively, generate high dynamic range images based on the current input image, the corresponding local motion compensated frame, the corresponding global motion compensated frame, or a combination thereof. The high dynamic range components respectively output, or otherwise make available, high dynamic range images to one or more other components of the image signal processor 620.

The high dynamic range components of the image signal processor 620 may, respectively, include one or more high dynamic range core components, one or more tone control (TC) components, or one or more high dynamic range core components and one or more tone control components. For example, the image signal processor 620 may include a high dynamic range component that includes a high dynamic range core component and a tone control component. The high dynamic range core component may obtain, or generate, combined image data, such as a high dynamic range image, by merging, fusing, or combining the image data, such as unsigned 14-bit RGB format image data, for multiple, such as two, images (HDR fusion) to obtain, and output, the high dynamic range image, such as in an unsigned 23-bit RGB format (full dynamic data). The high dynamic range core component may output the combined image data to the Tone Control component, or to other components of the image signal processor 620. The Tone Control component may compress the combined image data, such as from the unsigned 23-bit RGB format data to an unsigned 17-bit RGB format (enhanced dynamic data).

The image signal processor 620, or one or more components thereof, such as the three-dimensional noise reduction components reduce image noise for a frame based on one or more previously processed frames and output, or otherwise make available, noise reduced images to one or more other components of the image signal processor 620. In some implementations, the three-dimensional noise reduction component may be omitted or may be replaced by one or more lower-dimensional noise reduction components, such as by a spatial noise reduction component. The three-dimensional noise reduction components of the image signal processor 620 may, respectively, include one or more temporal noise reduction (TNR) components, one or more raw-to-raw (R2R) components, or one or more temporal noise reduction components and one or more raw-to-raw components. For example, the image signal processor 620 may include a three-dimensional noise reduction component that includes a temporal noise reduction component and a raw-to-raw component.

The image signal processor 620, or one or more components thereof, such as the sharpening components, obtains sharpened image data based on the image data, such as based on noise reduced image data, which may recover image detail, such as detail reduced by temporal denoising or warping. The sharpening components respectively output, or otherwise make available, sharpened image data to one or more other components of the image signal processor 620.

The image signal processor 620, or one or more components thereof, such as the raw-to-YUV components, may transform, or convert, image data, such as from the raw image format to another image format, such as the YUV format, which includes a combination of a luminance (Y) component and two chrominance (UV) components. The raw-to-YUV components may, respectively, demosaic, color process, or a both, images.

Although not expressly shown in FIG. 6, in some implementations, a respective raw-to-YUV component may include one or more sub-components. For example, the raw-to-YUV component may include a white balance (WB) component, which performs white balance correction on the image data. In another example, a respective raw-to-YUV component may include one or more color correction components (CC0, CC1), which may implement linear color rendering, which may include applying a 3×3 color matrix. For example, the raw-to-YUV component may include a first color correction component (CC0) and a second color correction component (CC1). In another example, a respective raw-to-YUV component may include a three-dimensional lookup table component, such as subsequent to a first color correction component. Although not expressly shown in FIG. 6, in some implementations, a respective raw-to-YUV component may include a Multi-Axis Color Correction (MCC) component, such as subsequent to a three-dimensional lookup table component, which may implement non-linear color rendering, such as in Hue, Saturation, Value (HSV) space.

In another example, a respective raw-to-YUV component may include a black point RGB removal (BPRGB) component, which may process image data, such as low intensity values, such as values within a defined intensity threshold, such as less than or equal to, 28, to obtain histogram data wherein values exceeding a defined intensity threshold may be omitted, or excluded, from the histogram data processing. In another example, a respective raw-to-YUV component may include a Multiple Tone Control (Multi-TC) component, which may convert image data, such as unsigned 17-bit RGB image data, to another format, such as unsigned 14-bit RGB image data. The Multiple Tone Control component may apply dynamic tone mapping to the Y channel (luminance) data, which may be based on, for example, image capture conditions, such as light conditions or scene conditions. The tone mapping may include local tone mapping, global tone mapping, or a combination thereof.

In another example, a respective raw-to-YUV component may include a Gamma (GM) component, which may convert image data, such as unsigned 14-bit RGB image data, to another format, such as unsigned 10-bit RGB image data. The Gamma component may apply a lookup-table independently per channel for color rendering (gamma curve application). Using a lookup-table, which may be an array, may reduce resource utilization, such as processor utilization, using an array indexing operation rather than more complex computation. In another example, a respective raw-to-YUV component may include a three-dimensional lookup table (3DLUT) component, which may include, or may be, a three-dimensional lookup table, which may map RGB input values to RGB output values through a non-linear function for non-linear color rendering. In another example, a respective raw-to-YUV component may include a Multi-Axis Color Correction (MCC) component, which may implement non-linear color rendering. For example, the multi-axis color correction component may perform color non-linear rendering, such as in Hue, Saturation, Value (HSV) space.

The image signal processor 620, or one or more components thereof, such as the Chroma Noise Reduction (CNR) components, may perform chroma denoising, luma denoising, or both.

The image signal processor 620, or one or more components thereof, such as the local tone mapping components, may perform multi-scale local tone mapping using a single pass approach or a multi-pass approach on a frame at different scales. The as the local tone mapping components may, respectively, enhance detail and may omit introducing artifacts. For example, the Local Tone Mapping components may, respectively, apply tone mapping, which may be similar to applying an unsharp-mask. Processing an image by the local tone mapping components may include obtaining, processing, such as in response to gamma correction, tone control, or both, and using a low-resolution map for local tone mapping.

The image signal processor 620, or one or more components thereof, such as the YUV-to-YUV (Y2Y) components, may perform local tone mapping of YUV images. In some implementations, the YUV-to-YUV components may include multi-scale local tone mapping using a single pass approach or a multi-pass approach on a frame at different scales.

The image signal processor 620, or one or more components thereof, such as the warp and blend components, may warp images, blend images, or both. In some implementations, the warp and blend components may warp a corona around the equator of a respective frame to a rectangle. For example, the warp and blend components may warp a corona around the equator of a respective frame to a rectangle based on the corresponding low-resolution frame. The warp and blend components, may, respectively, apply one or more transformations to the frames, such as to correct for distortions at image edges, which may be subject to a close to identity constraint.

The image signal processor 620, or one or more components thereof, such as the stitching cost components, may generate a stitching cost map, which may be represented as a rectangle having disparity (x) and longitude (y) based on a warping. Respective values of the stitching cost map may be a cost function of a disparity (x) value for a corresponding longitude. Stitching cost maps may be generated for various scales, longitudes, and disparities.

The image signal processor 620, or one or more components thereof, such as the scaler components, may scale images, such as in patches, or blocks, of pixels, such as 16×16 blocks, 8×8 blocks, or patches or blocks of any other size or combination of sizes.

The image signal processor 620, or one or more components thereof, such as the configuration controller, may control the operation of the image signal processor 620, or the components thereof.

The image signal processor 620 outputs processed image data, such as by storing the processed image data in a memory of the image capture apparatus, such as external to the image signal processor 620, or by sending, or otherwise making available, the processed image data to another component of the image processing pipeline 600, such as the encoder 630, or to another component of the image capture apparatus.

The encoder 630 encodes or compresses the output of the image signal processor 620. In some implementations, the encoder 630 implements one or more encoding standards, which may include motion estimation. The encoder 630 outputs the encoded processed image to an output 670. In an embodiment that does not include the encoder 630, the image signal processor 620 outputs the processed image to the output 670. The output 670 may include, for example, a display, such as a display of the image capture apparatus, such as one or more of the displays 108, 142 shown in FIGS. 1A-1B, the display 224 shown in FIG. 2B, the display 424 shown in FIG. 4A, or the display 566 shown in FIG. 5, to a storage device, or both. The output 670 is a signal, such as to an external device.

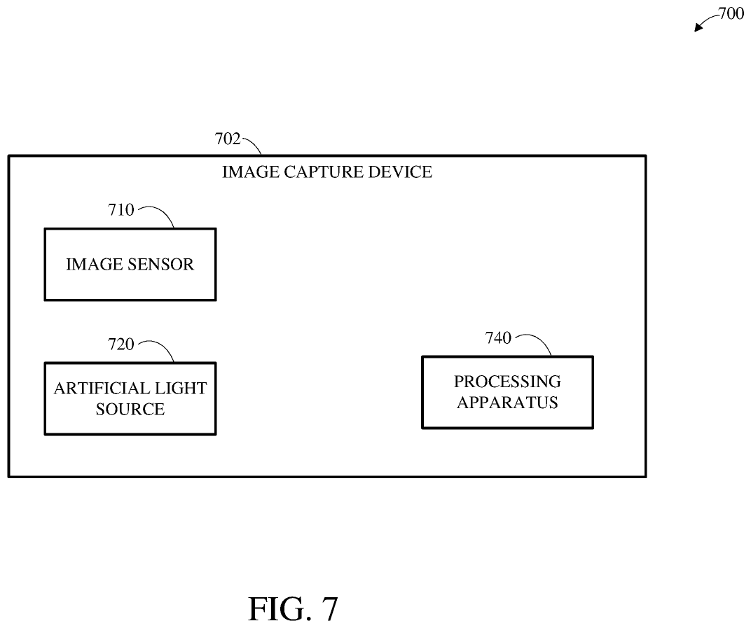

FIG. 7 is a block diagram of an example of a system 700 configured to use strobed light for enhanced video capture. The system 700 includes an image sensor 710, an artificial light source 720, and a processing apparatus 740. In this example, the image sensor 710, the artificial light source 720, and the processing apparatus 740 are components of an image capture device 702 (e.g., a camera). For example, the image capture device 702 may be the image capture apparatus 100, the image capture apparatus 200, the image capture apparatus 300, or the image capture apparatus 400. The image capture device 702 may include additional components (not shown in FIG. 7), such as the components of the image capture apparatus 500 of FIG. 5. The image capture device 702 may include the image processing pipeline 600. For example, processing apparatus 740 may include the image signal processor 620. The processing apparatus 740 is configured to access a first frame of video from the image sensor 710 that is captured while the artificial light source 720 is emitting light; access a second frame of video from the image sensor 710 that is captured while the artificial light source 720 is off; determine a parameter based on the second frame of video; and modify the first frame of video based on the parameter. For example, the second frame of video may provide information about the natural lighting conditions of a scene, and the parameter determined based on the second frame of video may be used to modify the first frame of video in a way that compensates for or mitigates impairments caused by the artificial light (e.g., unwanted changes in color temperature, brightness, and/or contrast). For example, the system 700 may be used to implement the process 1000 of FIG. 10. For example, the system 700 may be used to implement the process 1100 of FIG. 11.

The system 700 includes an image sensor 710 (e.g., the image sensor 512). The image sensor 710 is configured to capture images (e.g., frames of video). The image sensor 710 is configured to detect light of a certain spectrum (e.g., the visible spectrum or the infrared spectrum) and convey information constituting an image as electrical signals (e.g., analog or digital signals). For example, the image sensor 710 may include charge-coupled devices (CCD) or active pixel sensors in complementary metal-oxide-semiconductor (CMOS). The image sensor 710 may detect light incident through a lens (e.g., the first lens 330). For example, the lens may be a rectilinear lens or a fisheye lens. In some implementations, the image sensor 710 includes analog-to-digital converters. The image sensor 710 may be configured to capture frames of video with a rolling shutter. For example, an image may be captured as rows of pixels that are captured in sequence. The image sensor 710 may be configured to capture frames of video with a global shutter.

The system 700 includes an artificial light source 720. The artificial light source 720 may be used to cast additional light on a scene in the field of view of the image sensor 710 and thus increase a signal-to-noise ratio (SNR) of an image signal captured by the image sensor 710 while the artificial light source 720 is on and emitting light. The artificial light source 720 may be configured to emit light in a strobe pattern that is synchronized with periodic capture of frames of video using the image sensor 710. In some implementations, the artificial light source 720 includes one or more light emitting diodes.

The system 700 includes a processing apparatus 740. The processing apparatus 740 may include one or more processors having single or multiple processing cores. The processing apparatus 740 may include memory, such as random access memory device (RAM), flash memory, or any other suitable type of storage device such as a non-transitory computer readable memory. The memory of the processing apparatus 740 may include executable instructions and data that can be accessed by one or more processors of the processing apparatus 740. For example, the processing apparatus 740 may include one or more DRAM modules such as double data rate synchronous dynamic random-access memory (DDR SDRAM). In some implementations, the processing apparatus 740 may include a digital signal processor (DSP). In some implementations, the processing apparatus 740 may include an application specific integrated circuit (ASIC). For example, the processing apparatus 740 may include a custom image signal processor. In some implementations, the processing apparatus 740 may have multiple processing units in different portions the image capture device 702. For example, the processing apparatus 740 may include the processing components 520.

The processing apparatus 740 may be configured to access a first frame of video from the image sensor 710 that is captured while the artificial light source 720 is emitting light; access a second frame of video from the image sensor 710 that is captured while the artificial light source 720 is off (i.e., not emitting light); determine a parameter based on the second frame of video; and modify the first frame of video based on the parameter. The parameter may be used to perform signal processing on the first frame of video to correct for or mitigate unwanted effects of the light from the artificial light source 720. In some implementations, the parameter is a tuple of automatic white balance scale factors, which may be used to correct the color of the first frame of video to better match the color of the scene as it appears in the natural light of the scene. In some implementations, the parameter is a luminance scale factor used to adjust a contrast and/or a brightness of the first frame of video. The parameter may be applied to a portion (e.g., a block of pixels or the whole image) of the first frame of video. In some implementations, the processing apparatus 740 is configured to determine an artificial lighting ratio for a portion of the first frame of video by comparing the portion of the first frame of video to a corresponding portion of the second frame of video; and determine the parameter based on the artificial lighting ratio, wherein the parameter is used to modify the portion of the first frame of video. For example, the portion of the first frame of video may correspond to a pixel of a reduced resolution thumbnail of the first frame of video, wherein a luminance value of the pixel is used to determine the artificial lighting ratio. For example, the processing apparatus 740 may be configured to determine the parameter as a convex sum of a first parameter value associated with the first frame of video and a second parameter value associated with the second frame of video. Coefficients of the convex sum may be determined based on the artificial lighting ratio. For example, the processing apparatus 740 may be configured to determine the parameter by implementing the process 1100 of FIG. 11.

In cases where the image sensor 710 is configured to capture frames of video with a rolling shutter, a frame rate of the image sensor 710 may be four times a frequency of a strobe pattern of the artificial light source 720, and the processing apparatus 740 may be configured to: discard frames with a period of rolling shutter capture that includes an edge of the strobe pattern. For example, when capturing video, it is desirable to capture fully lit exposures and fully unlit exposures. A number of practical constraints may arise, such as: in rolling shutter mode, exposure of adjacent frames can overlap in time; artificial light should be strobed at a frequency high enough that it is not disturbing (e.g., greater than 60 Hz). In some implementations, frames of video are captured at a frequency of 240 FPS at 2.7K. In this mode the sensor readout may take 4 ms, whereas the maximum exposure time is 1/240=4.16 ms. This means there may be overlap between adjacent exposures. By strobing the flash at 60 Hz we are able to obtain, out of four consecutive exposures: 1 fully lit exposure; 1 fully unlit exposure; 2 partially lit exposure, which are discarded.

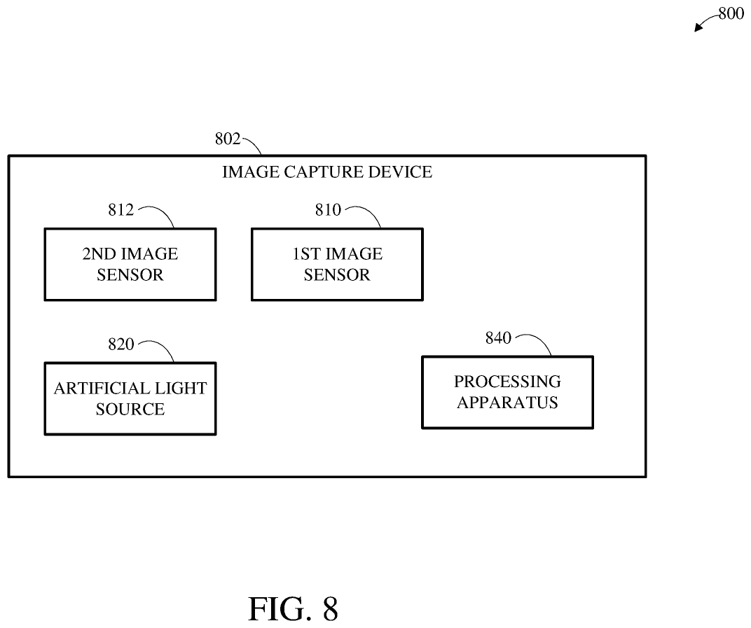

FIG. 8 is a block diagram of an example of a system 800 configured to use strobed light with a pair of image sensors for enhanced video capture. The system 800 includes a first image sensor 810, a second image sensor 812 with a field of view that overlaps with a field of view of the first image sensor 810, an artificial light source 820 configured to emit light in a strobe pattern that is synchronized with periodic capture of frames of video using the second image sensor 812, and a processing apparatus 840. In this example, the first image sensor 810, the second image sensor 812, the artificial light source 820, and the processing apparatus 840 are components of an image capture device 802 (e.g., a camera). For example, the image capture device 802 may be the image capture apparatus 100, the image capture apparatus 200, the image capture apparatus 300, or the image capture apparatus 400. The image capture device 802 may include additional components (not shown in FIG. 8), such as the components of the image capture apparatus 500 of FIG. 5. The image capture device 802 may include the image processing pipeline 600. For example, processing apparatus 840 may include the image signal processor 620. The processing apparatus 840 is configured to access a first frame of video from the first image sensor 810; access a second frame of video from the second image sensor 812 that is captured while the artificial light source 820 is off; determine a parameter based on the second frame of video; and modify the first frame of video based on the parameter. For example, the second frame of video may provide information about the natural lighting conditions of a scene, and the parameter determined based on the second frame of video may be used to modify the first frame of video in a way that compensates for or mitigates impairments caused by the artificial light (e.g., unwanted changes in color temperature, brightness, and/or contrast). For example, the system 800 may be used to implement the process 1000 of FIG. 10. For example, the system 800 may be used to implement the process 1100 of FIG. 11.

The system 800 includes a first image sensor 810 (e.g., the image sensor 512). The first image sensor 810 is configured to capture images (e.g., frames of video). The first image sensor 810 is configured to detect light of a certain spectrum (e.g., the visible spectrum or the infrared spectrum) and convey information constituting an image as electrical signals (e.g., analog or digital signals). For example, the first image sensor 810 may include charge-coupled devices (CCD) or active pixel sensors in complementary metal-oxide-semiconductor (CMOS). The first image sensor 810 may detect light incident through a lens (e.g., the first lens 330). For example, the lens may be a rectilinear lens or a fisheye lens. In some implementations, the first image sensor 810 includes analog-to-digital converters. The first image sensor 810 may be configured to capture frames of video with a rolling shutter. For example, an image may be captured as rows of pixels that are captured in sequence. The first image sensor 810 may be configured to capture frames of video with a global shutter.

The system 800 includes a second image sensor 812 (e.g., the image sensor 512) with a field of view that overlaps with a field of view of the first image sensor 810. In some implementations, the second image sensor 812 has a lower resolution than the first image sensor 810. For example, the second image sensor may be a single pixel (e.g., an RGB photodiode). In this example, the first image sensor 810 and the second image sensor 812 are both permanently attached to a body of an image capture device 802. The second image sensor 812 is configured to capture images (e.g., frames of video). The second image sensor 812 is configured to detect light of a certain spectrum (e.g., the visible spectrum or the infrared spectrum) and convey information constituting an image as electrical signals (e.g., analog or digital signals). For example, the second image sensor 812 may include charge-coupled devices (CCD) or active pixel sensors in complementary metal-oxide-semiconductor (CMOS). The second image sensor 812 may detect light incident through a lens (e.g., the first lens 330). For example, the lens may be a rectilinear lens or a fisheye lens. In some implementations, the second image sensor 812 includes analog-to-digital converters. The second image sensor 812 may be configured to capture frames of video with a rolling shutter. For example, an image may be captured as rows of pixels that are captured in sequence. The second image sensor 812 may be configured to capture frames of video with a global shutter.

The system 800 includes an artificial light source 820 configured to emit light in a strobe pattern that is synchronized with periodic capture of frames of video using the second image sensor 812. The artificial light source 820 may be used to cast additional light on a scene in the field of view of the first image sensor 810 and thus increase a signal-to-noise ratio (SNR) of an image signal captured by the first image sensor 810 while the artificial light source 820 is on and emitting light. In some implementations, the artificial light source 820 includes one or more light emitting diodes. The first image sensor 810 may be constrained to exposure times that are a multiple of a period of the strobed light pattern (e.g., 3.3 ms for a strobe frequency of 300 Hz). Enforcement of this constraint may ensure that all captured frames from the first image sensor 810 are evenly lit. In some implementations, an exposure time used to capture the first frame of video with the first image sensor 810 is a multiple of a period of the strobe pattern (e.g., 3.3 ms, 6.7 ms, or 10.0 ms for a strobe frequency of 300 Hz). In some implementations, information from the second image sensor 812, especially from frames lit with only natural light, may be combined with the images captured by the first image sensor 810 using an image processing algorithm to correct for impairments caused by the artificial light (e.g., as described in relation to FIGS. 10-11). In some implementations, information from the second image sensor 812 is used to adjust the strobed light color and intensity, so that the artificial additional light matches the natural light to mitigate disruption of the scene atmosphere by the artificial light.

The system 800 includes a processing apparatus 840. The processing apparatus 840 may include one or more processors having single or multiple processing cores. The processing apparatus 840 may include memory, such as random access memory device (RAM), flash memory, or any other suitable type of storage device such as a non-transitory computer readable memory. The memory of the processing apparatus 840 may include executable instructions and data that can be accessed by one or more processors of the processing apparatus 840. For example, the processing apparatus 840 may include one or more DRAM modules such as double data rate synchronous dynamic random-access memory (DDR SDRAM). In some implementations, the processing apparatus 840 may include a digital signal processor (DSP). In some implementations, the processing apparatus 840 may include an application specific integrated circuit (ASIC). For example, the processing apparatus 840 may include a custom image signal processor. In some implementations, the processing apparatus 840 may have multiple processing units in different portions the image capture device 802. For example, the processing apparatus 840 may include the processing components 520.

The processing apparatus 840 may be configured to access a first frame of video from the first image sensor 810; access a second frame of video from the second image sensor 812 that is captured while the artificial light source is off; determine a parameter based on the second frame of video; and modify the first frame of video based on the parameter. The parameter may be used to perform signal processing on the first frame of video to correct for or mitigate unwanted effects of the light from the artificial light source 820. In some implementations, the parameter is a tuple of automatic white balance scale factors, which may be used to correct the color of the first frame of video to better match the color of the scene as it appears in the natural light of the scene. In some implementations, the parameter is a luminance scale factor used to adjust a contrast and/or a brightness of the first frame of video. The parameter may be applied to a portion (e.g., a block of pixels or the whole image) of the first frame of video. In some implementations, the processing apparatus 840 is configured to determine an artificial lighting ratio for a portion of the first frame of video by comparing the portion of the first frame of video to a corresponding portion of the second frame of video; and determine the parameter based on the artificial lighting ratio, wherein the parameter is used to modify the portion of the first frame of video. For example, the portion of the first frame of video may correspond to a pixel of a reduced resolution thumbnail of the first frame of video, wherein a luminance value of the pixel is used to determine the artificial lighting ratio. For example, the processing apparatus 840 may be configured to determine the parameter as a convex sum of a first parameter value associated with the first frame of video and a second parameter value associated with the second frame of video. Coefficients of the convex sum may be determined based on the artificial lighting ratio. For example, the processing apparatus 840 may be configured to determine the parameter by implementing the process 1100 of FIG. 11.

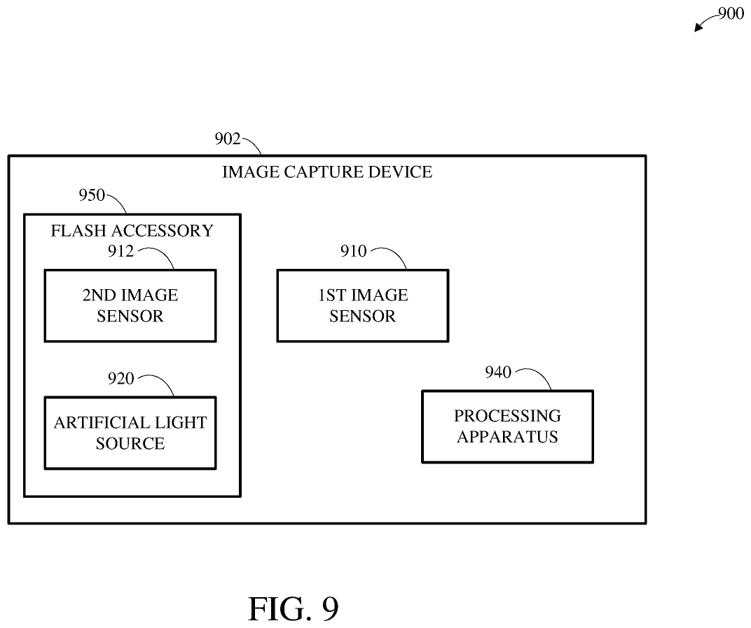

FIG. 9 is a block diagram of an example of a system 900 configured to use strobed light from a flash accessory with an additional image sensor for enhanced video capture. The system 900 includes a first image sensor 910, a second image sensor 912 with a field of view that overlaps with a field of view of the first image sensor 910, an artificial light source 920 configured to emit light in a strobe pattern that is synchronized with periodic capture of frames of video using the second image sensor 912, and a processing apparatus 940. In this example, the first image sensor 910, the second image sensor 912, the artificial light source 920, and the processing apparatus 940 are components of an image capture device 902 (e.g., a camera). The first image sensor 910 is permanently attached to a body of an image capture device 902, and the second image sensor 912 and the artificial light source 920 are both integrated in a flash accessory 950 that is removably attached to the body of the image capture device 902. For example, the image capture device 902 may be the image capture apparatus 100, the image capture apparatus 200, the image capture apparatus 300, or the image capture apparatus 400. The image capture device 902 may include additional components (not shown in FIG. 9), such as the components of the image capture apparatus 500 of FIG. 5. The image capture device 902 may include the image processing pipeline 600. For example, processing apparatus 940 may include the image signal processor 620. The processing apparatus 940 is configured to access a first frame of video from the first image sensor 910; access a second frame of video from the second image sensor 912 that is captured while the artificial light source 920 is off; determine a parameter based on the second frame of video; and modify the first frame of video based on the parameter. For example, the second frame of video may provide information about the natural lighting conditions of a scene, and the parameter determined based on the second frame of video may be used to modify the first frame of video in a way that compensates for or mitigates impairments caused by the artificial light (e.g., unwanted changes in color temperature, brightness, and/or contrast). For example, the system 900 may be used to implement the process 1000 of FIG. 10. For example, the system 900 may be used to implement the process 1100 of FIG. 11.

The system 900 includes a first image sensor 910 (e.g., the image sensor 512). The first image sensor 910 is configured to capture images (e.g., frames of video). The first image sensor 910 is configured to detect light of a certain spectrum (e.g., the visible spectrum or the infrared spectrum) and convey information constituting an image as electrical signals (e.g., analog or digital signals). For example, the first image sensor 910 may include charge-coupled devices (CCD) or active pixel sensors in complementary metal-oxide-semiconductor (CMOS). The first image sensor 910 may detect light incident through a lens (e.g., the first lens 330). For example, the lens may be a rectilinear lens or a fisheye lens. In some implementations, the first image sensor 910 includes analog-to-digital converters. The first image sensor 910 may be configured to capture frames of video with a rolling shutter. For example, an image may be captured as rows of pixels that are captured in sequence. The first image sensor 910 may be configured to capture frames of video with a global shutter.

The system 900 includes a second image sensor 912 (e.g., the image sensor 512) with a field of view that overlaps with a field of view of the first image sensor 910. In some implementations, the second image sensor 912 has a lower resolution than the first image sensor 910. For example, the second image sensor may be a single pixel (e.g., an RGB photodiode). The second image sensor 912 is configured to capture images (e.g., frames of video). The second image sensor 912 is configured to detect light of a certain spectrum (e.g., the visible spectrum or the infrared spectrum) and convey information constituting an image as electrical signals (e.g., analog or digital signals). For example, the second image sensor 912 may include charge-coupled devices (CCD) or active pixel sensors in complementary metal-oxide-semiconductor (CMOS). The second image sensor 912 may detect light incident through a lens (e.g., the first lens 330). For example, the lens may be a rectilinear lens or a fisheye lens. In some implementations, the second image sensor 912 includes analog-to-digital converters. The second image sensor 912 may be configured to capture frames of video with a rolling shutter. For example, an image may be captured as rows of pixels that are captured in sequence. The second image sensor 912 may be configured to capture frames of video with a global shutter.

The system 900 includes an artificial light source 920 configured to emit light in a strobe pattern that is synchronized with periodic capture of frames of video using the second image sensor 912. The artificial light source 920 may be used to cast additional light on a scene in the field of view of the first image sensor 910 and thus increase a signal-to-noise ratio (SNR) of an image signal captured by the first image sensor 910 while the artificial light source 920 is on and emitting light. In some implementations, the artificial light source 920 includes one or more light emitting diodes. The first image sensor 910 may be constrained to exposure times that are a multiple of a period of the strobed light pattern (e.g., 3.3 ms for a strobe frequency of 300 Hz). Enforcement of this constraint may ensure that all captured frames from the first image sensor 910 are evenly lit. In some implementations, an exposure time used to capture the first frame of video with the first image sensor 910 is a multiple of a period of the strobe pattern (e.g., 3.3 ms, 6.7 ms, or 10.0 ms for a strobe frequency of 300 Hz). In some implementations, information from the second image sensor 912, especially from frames lit with only natural light, may be combined with the images captured by the first image sensor 910 using an image processing algorithm to correct for impairments caused by the artificial light (e.g., as described in relation to FIGS. 10-11). In some implementations, information from the second image sensor 912 is used to adjust the strobed light color and intensity, so that the artificial additional light matches the natural light to mitigate disruption of the scene atmosphere by the artificial light.

In this example, the first image sensor 910 is permanently attached to a body of the image capture device 902, and the second image sensor 912 and the artificial light source 920 are both integrated in a flash accessory 950 that is removably attached to the body of the image capture device 902. For example, the flash accessory 950 may be removably attached to the body of the image capture device 902 using a bayonet mechanism. For example, the flash accessory 950 may be removably attached to the body of the image capture device 902 using a threaded mechanism. For example, the flash accessory 950 may be removably attached to the body of the image capture device 902 using a snap-ring mechanism.

The system 900 includes a processing apparatus 940. The processing apparatus 940 may include one or more processors having single or multiple processing cores. The processing apparatus 940 may include memory, such as random access memory device (RAM), flash memory, or any other suitable type of storage device such as a non-transitory computer readable memory. The memory of the processing apparatus 940 may include executable instructions and data that can be accessed by one or more processors of the processing apparatus 940. For example, the processing apparatus 940 may include one or more DRAM modules such as double data rate synchronous dynamic random-access memory (DDR SDRAM). In some implementations, the processing apparatus 940 may include a digital signal processor (DSP). In some implementations, the processing apparatus 940 may include an application specific integrated circuit (ASIC). For example, the processing apparatus 940 may include a custom image signal processor. In some implementations, the processing apparatus 940 may have multiple processing units in different portions the image capture device 902. For example, the processing apparatus 940 may include the processing components 520.

The processing apparatus 940 may be configured to access a first frame of video from the first image sensor 910; access a second frame of video from the second image sensor 912 that is captured while the artificial light source is off; determine a parameter based on the second frame of video; and modify the first frame of video based on the parameter. The parameter may be used to perform signal processing on the first frame of video to correct for or mitigate unwanted effects of the light from the artificial light source 920. In some implementations, the parameter is a tuple of automatic white balance scale factors, which may be used to correct the color of the first frame of video to better match the color of the scene as it appears in the natural light of the scene. In some implementations, the parameter is a luminance scale factor used to adjust a contrast and/or a brightness of the first frame of video. The parameter may be applied to a portion (e.g., a block of pixels or the whole image) of the first frame of video. In some implementations, the processing apparatus 940 is configured to determine an artificial lighting ratio for a portion of the first frame of video by comparing the portion of the first frame of video to a corresponding portion of the second frame of video; and determine the parameter based on the artificial lighting ratio, wherein the parameter is used to modify the portion of the first frame of video. For example, the portion of the first frame of video may correspond to a pixel of a reduced resolution thumbnail of the first frame of video, wherein a luminance value of the pixel is used to determine the artificial lighting ratio. For example, the processing apparatus 940 may be configured to determine the parameter as a convex sum of a first parameter value associated with the first frame of video and a second parameter value associated with the second frame of video. Coefficients of the convex sum may be determined based on the artificial lighting ratio. For example, the processing apparatus 940 may be configured to determine the parameter by implementing the process 1100 of FIG. 11.

FIG. 10 is flowchart of an example of a process 1000 for using strobed light for enhanced video capture by modifying a first frame of video captured with artificial light based on a second frame of video captured without the artificial light. The process 1000 includes accessing 1010 a first frame of video that is captured while an artificial light source is emitting light; accessing 1020 a second frame of video that is captured while the artificial light source is off; determining 1030 a parameter based on the second frame of video; and modifying 1040 the first frame of video based on the parameter. For example, the second frame of video may provide information about the natural lighting conditions of a scene, and the parameter determined based on the second frame of video may be used to modify the first frame of video in a way that compensates for or mitigates impairments caused by the artificial light (e.g., unwanted changes in color temperature, brightness, and/or contrast). In some implementations, luminance values of the first frame of video may be compared to corresponding luminance values of the second frame of video to assess what proportion of the lighting in a portion (e.g., a block of pixels) of the first frame of video is from the artificial light source. These localized comparisons of the two frames of video may be used to calibrate the parameter based on local conditions (e.g., foreground versus background). For example, the process 1000 may be implemented using the system 700 of FIG. 7. For example, the process 1000 may be implemented using the system 800 of FIG. 8. For example, the process 1000 may be implemented using the system 900 of FIG. 9.

The process 1000 includes accessing 1010 a first frame of video that is captured while an artificial light source (e.g., the artificial light source 720, the artificial light source 820, or the artificial light source 920) is emitting light. The first frame of video may have been captured using an image sensor (e.g., the image sensor 710, the first image sensor 810, or the first image sensor 910). The image sensor may be part of an image capture device (e.g., the image capture apparatus 100, the image capture apparatus 200, or the image capture apparatus 300). For example, the first frame of video may be a hyper-hemispherical image. For example, the first frame of video may be accessed 1010 from the image sensor or from memory via a bus using a memory interface (e.g., the storage interface 536). In some implementations, the first frame of video may be accessed 1010 via a communications interface (e.g., the I/O interface 532 or the wireless data interface 534). For example, the first frame of video may be accessed 1010 via a wireless or wired communications interface (e.g., Wi-Fi, Bluetooth, USB, HDMI, Wireless USB, Near Field Communication (NFC), Ethernet, a radio frequency transceiver, and/or other interfaces). For example, the first frame of video may be accessed 1010 via a front ISP that performs some initial processing on the accessed 1010 first frame of video. For example, the first frame of video may represent each pixel value in a defined format, such as in a RAW image signal format, a YUV image signal format, or a compressed format (e.g., an MPEG or JPEG compressed bitstream). For example, the first frame of video may be stored in a format using the Bayer color mosaic pattern.

The process 1000 includes accessing 1020 a second frame of video that is captured while the artificial light source is off (e.g., not emitting light during off phase of a strobe pattern). The second frame of video may have been captured using an image sensor (e.g., the image sensor 710, the second image sensor 812, or the second image sensor 912). The image sensor may be part of an image capture device (e.g., the image capture apparatus 100, the image capture apparatus 200, or the image capture apparatus 300). For example, the second frame of video may be a hyper-hemispherical image. For example, the second frame of video may be accessed 1020 from the image sensor or from memory via a bus using a memory interface (e.g., the storage interface 536). In some implementations, the second frame of video may be accessed 1020 via a communications interface (e.g., the I/O interface 532 or the wireless data interface 534). For example, the second frame of video may be accessed 1020 via a wireless or wired communications interface (e.g., Wi-Fi, Bluetooth, USB, HDMI, Wireless USB, Near Field Communication (NFC), Ethernet, a radio frequency transceiver, and/or other interfaces). For example, the second frame of video may be accessed 1020 via a front ISP that performs some initial processing on the accessed 1020 second frame of video. For example, the second frame of video may represent each pixel value in a defined format, such as in a RAW image signal format, a YUV image signal format, or a compressed format (e.g., an MPEG or JPEG compressed bitstream). For example, the second frame of video may be stored in a format using the Bayer color mosaic pattern.

To facilitate the capture of the first frame of video with artificial light and the second frame of video without the artificial light (e.g., with only the natural light of the scene), the artificial light source may emit light in a strobe pattern that is synchronized with periodic capture of frames of video, the frames of video including the second frame of video. In some implementations, the first frame of video and the second frame of video are captured using a same image sensor (e.g., the image sensor 710). In some implementations, the first frame of video is captured using a first image sensor (e.g., the first image sensor 810 or the first image sensor 910) and the second frame of video is captured using a second image sensor (e.g., the second image sensor 812 or the second image sensor 912) with field of view that overlaps with a field of view of the first image sensor. In some implementations, the second image sensor has a lower resolution than the first image sensor. For example, the second image sensor may be a single pixel (e.g., an RGB photodiode). In the two image sensors case, the phase of the strobe pattern may be synchronized to capture of frames of video with the second image sensor, while the capture of frames of video using the first image sensor may be allowed to vary in phase with respect to the strobe pattern where an exposure time used to capture the first frame of video is a multiple of a period of the strobe pattern.

The process 1000 includes determining 1030 a parameter based on the second frame of video; and modifying 1040 the first frame of video based on the parameter. The parameter may be used to perform signal processing on the first frame of video to correct for or mitigate unwanted effects of the light from the artificial light source (e.g., the artificial light source 720, the artificial light source 820, or the artificial light source 920). In some implementations, the parameter is a tuple of automatic white balance scale factors, which may be used to correct the color of the first frame of video to better match the color of the scene as it appears in the natural light of the scene. In some implementations, the parameter is a luminance scale factor used to adjust a contrast and/or a brightness of the first frame of video. The parameter may be applied to a portion (e.g., a block of pixels or the whole image) of the first frame of video. In some implementations, determining 1030 the parameter includes determining an artificial lighting ratio for a portion of the first frame of video by comparing the portion of the first frame of video to a corresponding portion of the second frame of video; and determining the parameter based on the artificial lighting ratio. The parameter may be used to modify the portion of the first frame of video. For example, the portion of the first frame of video may correspond to a pixel of a reduced resolution thumbnail of the first frame of video. A luminance value of the pixel may be used to determine the artificial lighting ratio. For example, determining 1030 the parameter may include determining the parameter as a convex sum of a first parameter value associated with the first frame of video and a second parameter value associated with the second frame of video. Coefficients of the convex sum may be determined based on the artificial lighting ratio. For example, determining 1030 the parameter may include implementing the process 1100 of FIG. 11.

When using a flashlight, illuminants of the scene are modified with the addition of a new light source: the flash. However, some camera current illuminant estimation algorithms can only estimate one illuminant to correct (e.g., correction of the illuminant may be called white balance). When two illuminants are present in a scene and illuminating different parts of the image (e.g., one illuminant for foreground and one for background in the flashlight case), two scenarios may occur. In a first scenario, the illuminant estimated may be a mix of both illuminants, such that no area of the image has its illuminant correctly balanced. In a second scenario, one illuminant takes over and a part of the image is correctly white balanced but the other part of the image is not correctly white balanced. By accessing a second frame of video captured without artificial light (e.g., no flash) using techniques described above, signal processing techniques may be implemented to apply a white balance correction that is locally variable in order to better correct artificial light (e.g., flashlight) color across different parts of a first frame video that is captured with added artificial light.

FIG. 11 is flowchart of an example of a process 1100 for determining a parameter for modifying the first frame of video based on the second frame of video. The process 1100 includes determining 1110 an artificial lighting ratio for a portion of the first frame of video by comparing the portion of the first frame of video to a corresponding portion of the second frame of video; and determining 1120 the parameter based on the artificial lighting ratio. The parameter may be used to modify the portion of the first frame of video. These localized comparisons of the two frames of video may be used to calibrate the parameter based on local conditions (e.g., foreground versus background). For example, the process 1100 may be implemented using the system 700 of FIG. 7. For example, the process 1100 may be implemented using the system 800 of FIG. 8. For example, the process 1100 may be implemented using the system 900 of FIG. 9.

For example, inputs to the process 1100 may include: a flashed image (the first frame of video) and a thumbnail of luminance (e.g., of size 64×48 pixels) for the flashed image; a luminance thumbnail of the no-flash image (the second frame of video); a candidate parameter value, which may be a result of application of an automatic white balance (AWB) algorithm to the no-flash image. In this example, the flash image and the no-flash images might have been captured with different exposure parameters (exposure time, gain). The flash image thumbnail (thumb_{Flash}) may be aligned to the no-flash thumbnail (thumb_{NoFlash}) for comparison by multiplying it by ratio of exposures:

thumb_{Flash_aligned}=thumb_{Flash}*time_{NoFlash}*gain_{NoFlash}/time_{Flash}*gain_{Flash}

A proportion of luminance coming from flash (i.e., an artificial lighting ratio) may be locally estimated in each portion (e.g., a block of pixels, which may correspond to a single pixel of the flash image thumbnail) of the flash image using:

thumb_{Flash_ratio}=∥thumb_{Flash_aligned}−thumb_{NoFlash}∥/thumb_{Flash_aligned}

Now that flash impact on image has been computed locally, white balance can be locally applied. The more the flash prevails on a pixel, the more its color is corrected. Color of the flash may be pre-calibrated in a lab to obtain a candidate parameter value (e.g., corresponding color scales) for flash dominated portions of an image to use to correct it: scales_{Flash_calib}. For areas of the image not affected by the flash, a candidate parameter value resulting from white balance for the no-flash image should be used: scales_{NoFlash}. A final map of scales may be determined as a linear combination of those candidate parameter values (e.g., scales) weighted by artificial lighting ratio in each portion of the frame of video:

correction_map=scales_{Flash_calib}*thumb_{Flash_ratio}+scales_{NoFlash}*(1−thumb_{Flash_ratio})

The process 1100 includes determining 1110 an artificial lighting ratio (e.g., thumb_{Flash_ratio}) for a portion of the first frame of video by comparing the portion of the first frame of video to a corresponding portion of the second frame of video. In some implementations, the portion of the first frame of video corresponds to a pixel of a reduced resolution thumbnail of the first frame of video. A luminance value of the pixel may be used to determine the artificial lighting ratio. In some implementations, the process 1100 includes determining the parameter (e.g., correction_map) as a convex sum of a first parameter value (e.g., scales_{Flash_calib}) associated with the first frame of video and a second parameter value (e.g., scales_{NoFlash}) associated with the second frame of video. Coefficients of the convex sum may be determined based on the artificial lighting ratio.

The process 1100 includes determining 1120 the parameter based on the artificial lighting ratio. The parameter may be used to modify the portion of the first frame of video.

The methods and techniques described herein, or aspects thereof, may be implemented by an image capture apparatus, or one or more components thereof, such as the image capture apparatus 100 shown in FIGS. 1A-1B, the image capture apparatus 200 shown in FIGS. 2A-2B, the image capture apparatus 300 shown in FIG. 3, the image capture apparatus 400 shown in FIGS. 4A-4B, or the image capture apparatus 500 shown in FIG. 5. The methods and techniques of strobed light for enhanced video capture described herein, or aspects thereof, may be implemented by an image capture device, such as the image capture device 104 shown in FIGS. 1A-1B, one or more of the image capture devices 204, 206 shown in FIGS. 2A-2B, one or more of the image capture devices 304, 306 shown in FIG. 3, the image capture device 404 shown in FIGS. 4A-4B, or an image capture device of the image capture apparatus 500 shown in FIG. 5. The methods and techniques of strobed light for enhanced video capture described herein, or aspects thereof, may be implemented by an image processing pipeline, or one or more components thereof, such as the image processing pipeline 600 shown in FIG. 6.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A system comprising:
a first image sensor,
a second image sensor with a field of view that overlaps with a field of view of the first image sensor,
an artificial light source configured to emit light in a strobe pattern that is synchronized with periodic capture of frames of video using the second image sensor, and
a processing apparatus configured to:
access a first frame of video from the first image sensor;
access a second frame of video from the second image sensor that is captured while the artificial light source is off;
determine a parameter based on the second frame of video; and
modify the first frame of video based on the parameter.

2. The system of claim 1, in which the parameter is a tuple of automatic white balance scale factors.

3. The system of claim 1, in which the parameter is a luminance scale factor used to adjust a brightness of the first frame of video.

4. The system of claim 1, in which the second image sensor has a lower resolution than the first image sensor.

5. The system of claim 1, in which the first image sensor and the second image sensor are both permanently attached to a body of an image capture device.

6. The system of claim 1, in which the first image sensor is permanently attached to a body of an image capture device, and the second image sensor and the artificial light source are both integrated in a flash accessory that is removably attached to the body of the image capture device.

7. The system of claim 1, wherein the processing apparatus is configured to:
determine an artificial lighting ratio for a portion of the first frame of video by comparing the portion of the first frame of video to a corresponding portion of the second frame of video; and
determine the parameter based on the artificial lighting ratio, wherein the parameter is used to modify the portion of the first frame of video.

8. The system of claim 7, in which the portion of the first frame of video corresponds to a pixel of a reduced resolution thumbnail of the first frame of video, wherein a luminance value of the pixel is used to determine the artificial lighting ratio.

9. The system of claim 7, wherein the processing apparatus is configured to:
determine the parameter as a convex sum of a first parameter value associated with the first frame of video and a second parameter value associated with the second frame of video, wherein coefficients of the convex sum are determined based on the artificial lighting ratio.

10. A method comprising:
accessing a first frame of video that is captured while an artificial light source is emitting light;
accessing a second frame of video that is captured while the artificial light source is off;
determining a parameter based on the second frame of video; and
modifying the first frame of video based on the parameter.

11. The method of claim 10, in which the artificial light source emits light in a strobe pattern that is synchronized with periodic capture of frames of video, the frames of video including the second frame of video.

12. The method of claim 10, in which the parameter is a tuple of automatic white balance scale factors.

13. The method of claim 10, in which the parameter is a luminance scale factor used to adjust a contrast of the first frame of video.

14. The method of claim 10, comprising:
determining an artificial lighting ratio for a portion of the first frame of video by comparing the portion of the first frame of video to a corresponding portion of the second frame of video; and
determining the parameter based on the artificial lighting ratio, wherein the parameter is used to modify the portion of the first frame of video.

15. The method of claim 14, in which the portion of the first frame of video corresponds to a pixel of a reduced resolution thumbnail of the first frame of video, wherein a luminance value of the pixel is used to determine the artificial lighting ratio.

16. The method of claim 14, comprising:
determining the parameter as a convex sum of a first parameter value associated with the first frame of video and a second parameter value associated with the second frame of video, wherein coefficients of the convex sum are determined based on the artificial lighting ratio.

17. A system comprising:
an image sensor,
an artificial light source, and
a processing apparatus configured to:
access a first frame of video from the image sensor that is captured while the artificial light source is emitting light;
access a second frame of video from the image sensor that is captured while the artificial light source is off;
determine a parameter based on the second frame of video; and
modify the first frame of video based on the parameter.

18. The system of claim 17, in which the artificial light source is configured to emit light in a strobe pattern that is synchronized with periodic capture of frames of video using the image sensor.

19. The system of claim 18, in which the image sensor is configured to capture frames of video with a rolling shutter, a frame rate of the image sensor is four times a frequency of the strobe pattern, and the processing apparatus is configured to:
discard frames with a period of rolling shutter capture that includes an edge of the strobe pattern.

20. The system of claim 17, wherein the processing apparatus is configured to:
determine an artificial lighting ratio for a portion of the first frame of video by comparing the portion of the first frame of video to a corresponding portion of the second frame of video; and
determine the parameter based on the artificial lighting ratio, wherein the parameter is used to modify the portion of the first frame of video.
